(19) United States
(12) Patent Application Publication
(10) Pub. No.: US 2023/0385779 A1
(43) Pub. Date: Nov. 30, 2023

(54) SYSTEMS AND METHODS FOR SCHEDULING MULTIPLE PARTICIPANT TASKS

(71) Applicant: Citrix Systems, Inc., Fort Lauderdale, FL (US)

(72) Inventors: Jia Yin, Nanjing (CN); Chuchu Ye, Nanjing (CN); Ke Xu, Nanjing (CN); Shuai Ye, Nanjing (CN)

(21) Appl. No.: 17/808,329

(22) Filed: Jun. 23, 2022

Related U.S. Application Data
(63) Continuation of application No. PCT/CN2022/095237, filed on May 26, 2022.

(51) Int. Cl. G06Q 10/10; G06Q 10/06

(52) U.S. Cl. CPC G06Q 10/1097; G06Q 10/063116; G06Q 10/06316

(57) ABSTRACT

In one aspect, an example methodology implementing the disclosed techniques can include, by a computing device, identifying a task from a plurality of tasks that need to be scheduled and determining other tasks associated with participants associated with the task. The method may also include, by the computing device, determining one or more periods of time when the participants associated with the task are unavailable and determining one or more candidate time slots for the task based on time slots for which the other tasks are scheduled and the one or more periods of time when the participants associated with the task are unavailable. The method may further include, by the computing device, scheduling the task to be performed during one of the determined one or more candidate time slots.

### CROSS REFERENCE TO RELATED APPLICATIONS

This application is a continuation of and claims the benefit of PCT Patent Application No. PCT/CN2022/095237 filed on May 26, 2022 in the English language in the State Intellectual Property Office and designating the United States, the contents of which are hereby incorporated herein by reference in its entirety.

### BACKGROUND

Various software applications and services allow tasks to be assigned to users. A task may require contributions from multiple users, e.g., different users within the same company enterprise, firm, or other type of organization, to successfully perform the task. For example, a user within an organization, such as a project manager, may use a project management tool to create and assign a task (or “ticket”) to another user within the organization, such as a team leader. The team leader may then identify and associate other users within the organization, such as co-workers or other team members, whose participation/cooperation is needed in order to complete the task. It is not uncommon for the tasks to have a due date, meaning a date or time by which the task is expected to be completed, such as two weeks, four weeks, six weeks, etc. Users within a team may be permitted to take scheduled time off (e.g., paid time off), which can complicate task scheduling.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

Before a user (e.g., a project manager) schedules a task, the user may access several different applications to search for information which is needed to properly schedule the task. For example, the user may access different applications to search for other tasks assigned to the user and which are coming due. The user may access different applications to search for tasks associated with other users who are associated with the user's task (i.e., tasks associated with other participants associated with the user's task) and which are coming due. The user may further access different applications to search for scheduled time off of the other users who are associated with the user's task. Then, the user may login to a particular application and perform more actions, which actions may vary from application to application, to properly schedule the task to be completed within the due date. Such effort can be time consuming for the user and result in increased resource usage by computing devices used to host and access the several different applications. The user may also find it challenging to schedule the user's tasks around the scheduled time off.

Disclosed embodiments can be applied to enhance the efficiency and utility of existing project management systems and applications (e.g., CITRIX WRIKE) by, for example, accurately computing the availability of users whose participation/cooperation is needed to complete a task. Moreover, by accurately computing the availability of users needed to complete the task, disclosed embodiments can reduce the time and resources consumed to accurately schedule the task for completion. Thus, embodiments of the present disclosure not only increase user productivity, but also can reduce computer resource usage, such as processor, network, and storage usage.

In accordance with one example embodiment provided to illustrate the broader concepts, systems, and techniques described herein, a method includes, by a computing device, identifying a first task from a plurality of tasks that need to be scheduled and determining other tasks associated with participants associated with the first task. The method also includes, by the computing device, determining one or more periods of time when the participants associated with the first task are unavailable and determining one or more candidate time slots for the first task based on time slots for which the other tasks are scheduled and the one or more periods of time when the participants associated with the first task are unavailable. The method further includes, by the computing device, scheduling the first task to be performed during one of the determined one or more candidate time slots.

In some embodiments, identifying of the first task includes determining that the first task is associated with a number of participants larger than that of other ones of the plurality of tasks.

In some embodiments, identifying of the first task includes determining that the first task has a priority higher than that of other ones of the plurality of tasks associated with a same number of participants as the first task.

In some embodiments, the method further includes, by the computing device, responsive to a determination that there are no candidate time slots for the first task, determining whether there is a scheduled task available to reschedule and, responsive to a determination that there are no scheduled tasks available to reschedule, indicating the first task as being not schedulable.

In some embodiments, the method further includes, by the computing device, responsive to a determination that there are one or more scheduled tasks available to reschedule: selecting one of the one or more scheduled tasks for rescheduling, descheduling scheduled tasks which were scheduled subsequent to the scheduling of the selected one of the scheduled tasks for rescheduling, and rescheduling the selected one of the scheduled tasks.

In some embodiments, the method further includes causing, by the computing device, information regarding the scheduling of the first task to be displayed in a user interface (UI) of an application on a remote computing device.

In some embodiments, the method further includes, by the computing device, identifying a second task from the plurality of tasks that need to be scheduled and scheduling the second task by: determining other tasks associated with participants associated with the second task, determining other tasks associated with participants associated with the second task, determining one or more periods of time when the participants associated with the second task are unavailable, determining one or more candidate time slots for the second task based on time slots for which the other tasks are scheduled and the one or more periods of time when the participants associated with the second task are unavailable, and scheduling the second task to be performed during one of the determined one or more candidate time slots for the second task.

In some embodiments, the method further includes causing, by the computing device, information regarding the scheduling of the second task to be displayed in a user interface (UI) of an application on a remote computing device.

According to another illustrative embodiment provided to illustrate the broader concepts described herein, a system includes a processor and a non-volatile memory storing computer program code that when executed on the processor, causes the processor to execute a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIG. 4A is a block diagram of an illustrative system in which resource management services may manage and streamline access by clients to resource feeds (via one or more gateway services) and/or software-as-a-service (SaaS) applications.

FIG. 4B is a block diagram showing an illustrative implementation of the system shown in FIG. 4A in which various resource management services as well as a gateway service are located within a cloud computing environment.

FIG. 4C is a block diagram similar to FIG. 4B but in which the available resources are represented by a single box labeled “systems of record,” and further in which several different services are included among the resource management services.

FIG. 5 is a block diagram of an illustrative system for scheduling tasks for completion by a given time, in accordance with an embodiment of the present disclosure.

FIG. 6 is a diagram of a graph illustrating a scheduling of tasks by application of a greedy technique, in accordance with an embodiment of the present disclosure.

FIG. 7 is a flow diagram of an illustrative process for scheduling tasks, in accordance with an embodiment of the present disclosure.

FIG. 8 is a flow diagram of an illustrative process for determining candidate time slots suitable for scheduling a task, in accordance with an embodiment of the present disclosure.

FIGS. 9A-9Q are diagrams of example user interfaces (UIs) showing various stages of a scheduling process, in accordance with an embodiment of the present disclosure.

FIG. 9R is a diagram showing an example user interface (UI) that can be used to present a schedule for tasks, in accordance with an embodiment of the present disclosure.

### DETAILED DESCRIPTION

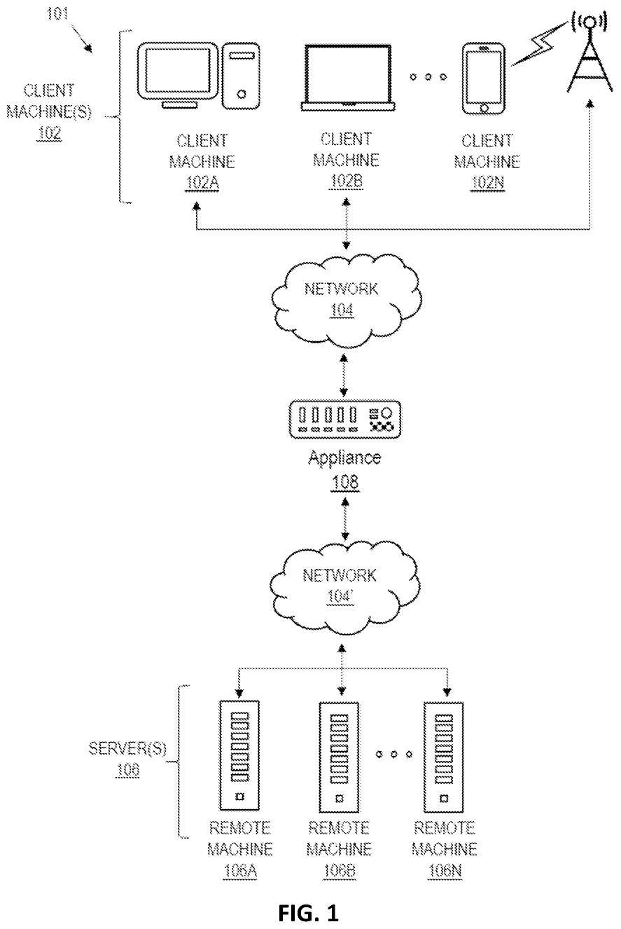

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

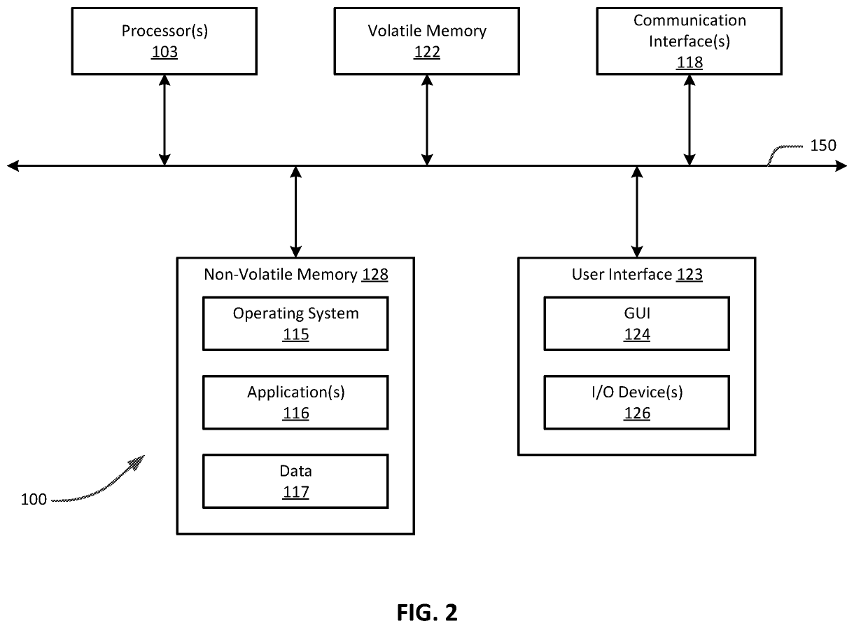

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

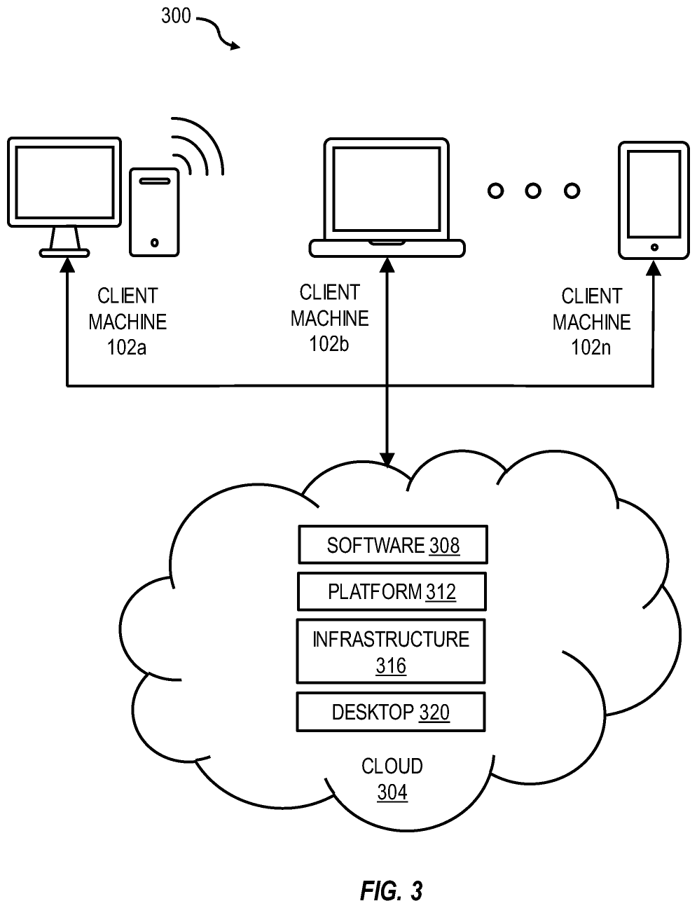

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one illustrative implementation, cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., Citrix ShareFile from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

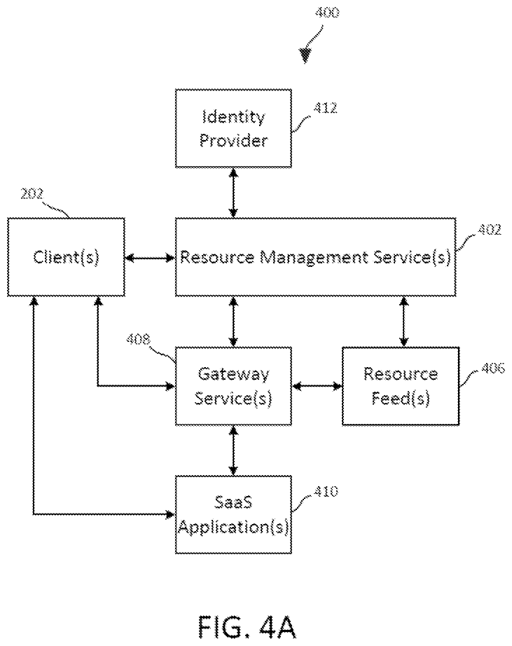

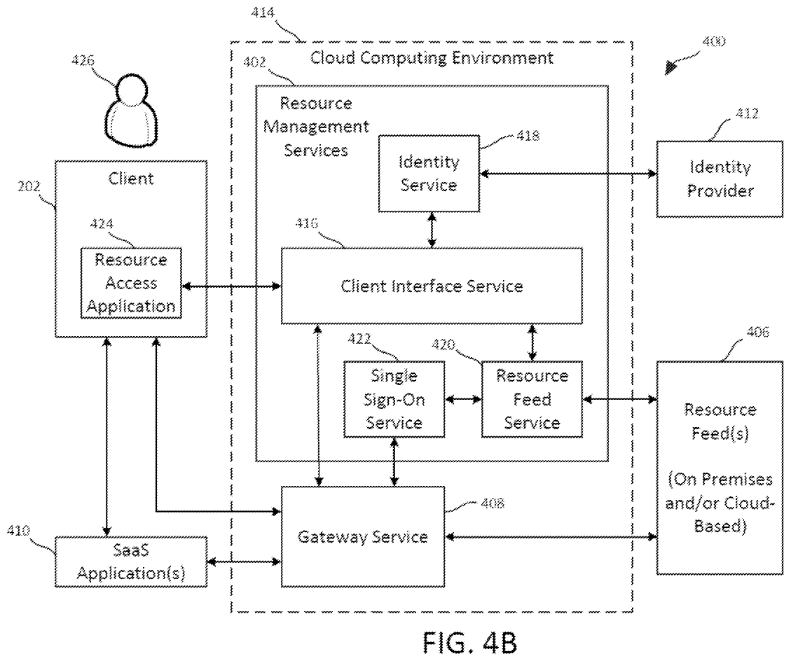

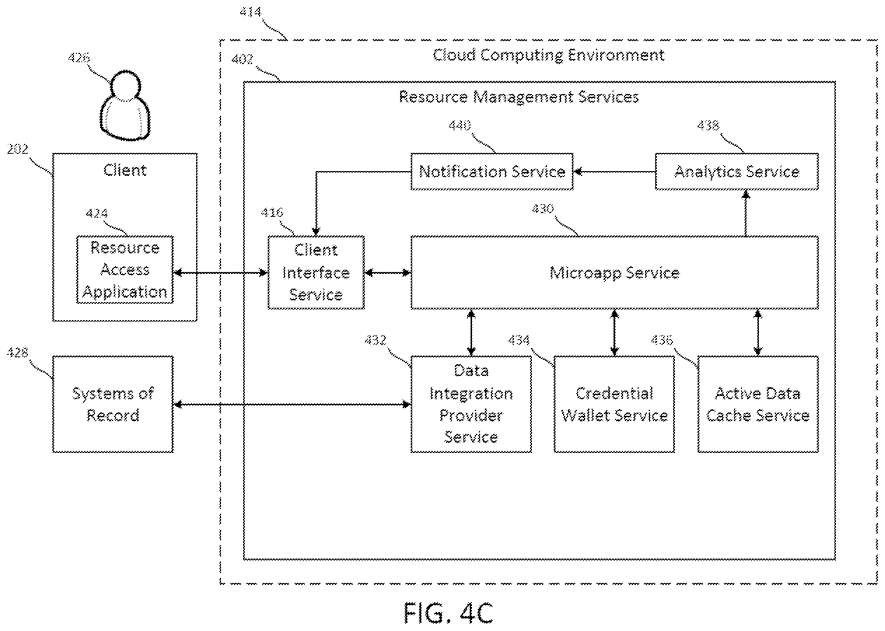

FIG. 4A is a block diagram of an illustrative system 400 in which one or more resource management services 402 may manage and streamline access by one or more clients 202 to one or more resource feeds 406 (via one or more gateway services 408) and/or one or more software-as-a-service (SaaS) applications 410. In particular, resource management service(s) 402 may employ an identity provider 412 to authenticate the identity of a user of a client 202 and, following authentication, identify one of more resources the user is authorized to access. In response to the user selecting one of the identified resources, resource management service(s) 402 may send appropriate access credentials to the requesting client 202, and the requesting client 202 may then use those credentials to access the selected resource. For resource feed(s) 406, client 202 may use the supplied credentials to access the selected resource via gateway service 408. For SaaS application(s) 410, client 202 may use the credentials to access the selected application directly.

Client(s) 202 may be any type of computing devices capable of accessing resource feed(s) 406 and/or SaaS application(s) 410, and may, for example, include a variety of desktop or laptop computers, smartphones, tablets, etc. Resource feed(s) 406 may include any of numerous resource types and may be provided from any of numerous locations. In some embodiments, for example, resource feed(s) 406 may include one or more systems or services for providing virtual applications and/or desktops to client(s) 202, one or more file repositories and/or file sharing systems, one or more secure browser services, one or more access control services for SaaS applications 410, one or more management services for local applications on client(s) 202, one or more internet enabled devices or sensors, etc. Each of resource management service(s) 402, resource feed(s) 406, gateway service(s) 408, SaaS application(s) 410, and identity provider 412 may be located within an on-premises data center of an organization for which system 400 is deployed, within one or more cloud computing environments, or elsewhere.

FIG. 4B is a block diagram showing an illustrative implementation of system 400 shown in FIG. 4A in which various resource management services 402 as well as gateway service 408 are located within a cloud computing environment 414. The cloud computing environment may, for example, include Microsoft Azure Cloud, Amazon Web Services, Google Cloud, or IBM Cloud.

For any of illustrated components (other than client 202) that are not based within cloud computing environment 414, cloud connectors (not shown in FIG. 4B) may be used to interface those components with cloud computing environment 414. Such cloud connectors may, for example, run on Windows Server instances hosted in resource locations and may create a reverse proxy to route traffic between the site(s) and cloud computing environment 414. In the illustrated example, the cloud-based resource management services 402 include a client interface service 416, an identity service 418, a resource feed service 420, and a single sign-on service 422. As shown, in some embodiments, client 202 may use a resource access application 424 to communicate with client interface service 416 as well as to present a user interface on client 202 that a user 426 can operate to access resource feed(s) 406 and/or SaaS application(s) 410. Resource access application 424 may either be installed on client 202 or may be executed by client interface service 416 (or elsewhere in system 400) and accessed using a web browser (not shown in FIG. 4B) on client 202.

As explained in more detail below, in some embodiments, resource access application 424 and associated components may provide user 426 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When resource access application 424 is launched or otherwise accessed by user 426, client interface service 416 may send a sign-on request to identity service 418. In some embodiments, identity provider 412 may be located on the premises of the organization for which system 400 is deployed. Identity provider 412 may, for example, correspond to an on-premises Windows Active Directory. In such embodiments, identity provider 412 may be connected to the cloud-based identity service 418 using a cloud connector (not shown in FIG. 4B), as described above. Upon receiving a sign-on request, identity service 418 may cause resource access application 424 (via client interface service 416) to prompt user 426 for the user's authentication credentials (e.g., username and password). Upon receiving the user's authentication credentials, client interface service 416 may pass the credentials along to identity service 418, and identity service 418 may, in turn, forward them to identity provider 412 for authentication, for example, by comparing them against an Active Directory domain. Once identity service 418 receives confirmation from identity provider 412 that the user's identity has been properly authenticated, client interface service 416 may send a request to resource feed service 420 for a list of subscribed resources for user 426.

In other embodiments (not illustrated in FIG. 4B), identity provider 412 may be a cloud-based identity service, such as a Microsoft Azure Active Directory. In such embodiments, upon receiving a sign-on request from client interface service 416, identity service 418 may, via client interface service 416, cause client 202 to be redirected to the cloud-based identity service to complete an authentication process. The cloud-based identity service may then cause client 202 to prompt user 426 to enter the user's authentication credentials. Upon determining the user's identity has been properly authenticated, the cloud-based identity service may send a message to resource access application 424 indicating the authentication attempt was successful, and resource access application 424 may then inform client interface service 416 of the successfully authentication. Once identity service 418 receives confirmation from client interface service 416 that the user's identity has been properly authenticated, client interface service 416 may send a request to resource feed service 420 for a list of subscribed resources for user 426.

For each configured resource feed, resource feed service 420 may request an identity token from single sign-on service 422. Resource feed service 420 may then pass the feed-specific identity tokens it receives to the points of authentication for the respective resource feeds 406. Each resource feed 406 may then respond with a list of resources configured for the respective identity. Resource feed service 420 may then aggregate all items from the different feeds and forward them to client interface service 416, which may cause resource access application 424 to present a list of available resources on a user interface of client 202. The list of available resources may, for example, be presented on the user interface of client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on client 202, and/or one or more SaaS applications 410 to which user 426 has subscribed. The lists of local applications and SaaS applications 410 may, for example, be supplied by resource feeds 406 for respective services that manage which such applications are to be made available to user 426 via resource access application 424. Examples of SaaS applications 410 that may be managed and accessed as described herein include Microsoft Office 365 applications, SAP SaaS applications, Workday applications, etc.

For resources other than local applications and SaaS application(s) 410, upon user 426 selecting one of the listed available resources, resource access application 424 may cause client interface service 416 to forward a request for the specified resource to resource feed service 420. In response to receiving such a request, resource feed service 420 may request an identity token for the corresponding feed from single sign-on service 422. Resource feed service 420 may then pass the identity token received from single sign-on service 422 to client interface service 416 where a launch ticket for the resource may be generated and sent to resource access application 424. Upon receiving the launch ticket, resource access application 424 may initiate a secure session to gateway service 408 and present the launch ticket. When gateway service 408 is presented with the launch ticket, it may initiate a secure session to the appropriate resource feed and present the identity token to that feed to seamlessly authenticate user 426. Once the session initializes, client 202 may proceed to access the selected resource.

When user 426 selects a local application, resource access application 424 may cause the selected local application to launch on client 202. When user 426 selects SaaS application 410, resource access application 424 may cause client interface service 416 request a one-time uniform resource locator (URL) from gateway service 408 as well a preferred browser for use in accessing SaaS application 410. After gateway service 408 returns the one-time URL and identifies the preferred browser, client interface service 416 may pass that information along to resource access application 424. Client 202 may then launch the identified browser and initiate a connection to gateway service 408. Gateway service 408 may then request an assertion from single sign-on service 422. Upon receiving the assertion, gateway service 408 may cause the identified browser on client 202 to be redirected to the logon page for identified SaaS application 410 and present the assertion. The SaaS may then contact gateway service 408 to validate the assertion and authenticate user 426. Once the user has been authenticated, communication may occur directly between the identified browser and the selected SaaS application 410, thus allowing user 426 to use client 202 to access the selected SaaS application 410.

In some embodiments, the preferred browser identified by gateway service 408 may be a specialized browser embedded in resource access application 424 (when the resource application is installed on client 202) or provided by one of the resource feeds 406 (when resource access application 424 is located remotely), e.g., via a secure browser service. In such embodiments, SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have client interface service 416 send the link to a secure browser service, which may start a new virtual browser session with client 202, and thus allow the user to access the potentially harmful linked content in a safe environment.

In some embodiments, in addition to or in lieu of providing user 426 with a list of resources that are available to be accessed individually, as described above, user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify user 426 of something that requires the user's attention (e.g., approval of an expense report, new course available for registration, etc.).

FIG. 4C is a block diagram similar to that shown in FIG. 4B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 4C may enable the provision of a streamlined resource activity feed and/or notification process for client 202. In the example shown, in addition to client interface service 416 discussed above, the illustrated services include a microapp service 430, a data integration provider service 432, a credential wallet service 434, an active data cache service 436, an analytics service 438, and a notification service 440. In various embodiments, the services shown in FIG. 4C may be employed either in addition to or instead of the different services shown in FIG. 4B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within resource access application 424 without having to launch the native application. The system shown in FIG. 4C may, for example, aggregate relevant notifications, tasks, and insights, and thereby give user 426 a dynamic productivity tool. In some embodiments, the resource activity feed may be intelligently populated by utilizing machine learning and artificial intelligence (AI) algorithms. Further, in some implementations, microapps may be configured within cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4C, systems of record 428 may represent the applications and/or other resources resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. Resource management services 402, and in particular data integration provider service 432, may, for example, support REST API, JSON, OData-JSON, and 6ML. As explained in more detail below, data integration provider service 432 may also write back to the systems of record, for example, using OAuth2 or a service account.

In some embodiments, microapp service 430 may be a single-tenant service responsible for creating the microapps. Microapp service 430 may send raw events, pulled from systems of record 428, to analytics service 438 for processing. The microapp service may, for example, periodically pull active data from systems of record 428.

In some embodiments, active data cache service 436 may be single-tenant and may store all configuration information and microapp data. It may, for example, utilize a per-tenant database encryption key and per-tenant database credentials.

In some embodiments, credential wallet service 434 may store encrypted service credentials for systems of record 428 and user OAuth2 tokens.

In some embodiments, data integration provider service 432 may interact with systems of record 428 to decrypt end-user credentials and write back actions to systems of record 428 under the identity of the end-user. The write-back actions may, for example, utilize a user's actual account to ensure all actions performed are compliant with data policies of the application or other resource being interacted with.

In some embodiments, analytics service 438 may process the raw events received from microapps service 430 to create targeted scored notifications and send such notifications to notification service 440.

Finally, in some embodiments, notification service 440 may process any notifications it receives from analytics service 438. In some implementations, notification service 440 may store the notifications in a database to be later served in a notification feed. In other embodiments, notification service 440 may additionally or alternatively send the notifications out immediately to client 202 as a push notification to user 426.

In some embodiments, a process for synchronizing with systems of record 428 and generating notifications may operate as follows. Microapp service 430 may retrieve encrypted service account credentials for systems of record 428 from credential wallet service 434 and request a sync with data integration provider service 432. Data integration provider service 432 may then decrypt the service account credentials and use those credentials to retrieve data from systems of record 428. Data integration provider service 432 may then stream the retrieved data to microapp service 430. Microapp service 430 may store the received systems of record data in active data cache service 436 and also send raw events to analytics service 438. Analytics service 438 may create targeted scored notifications and send such notifications to notification service 440. Notification service 440 may store the notifications in a database to be later served in a notification feed and/or may send the notifications out immediately to client 202 as a push notification to user 426.

In some embodiments, a process for processing a user-initiated action via a microapp may operate as follows. Client 202 may receive data from microapp service 430 (via client interface service 416) to render information corresponding to the microapp. Microapp service 430 may receive data from active data cache service 436 to support that rendering. User 426 may invoke an action from the microapp, causing resource access application 424 to send that action to microapp service 430 (via client interface service 416). Microapp service 430 may then retrieve from credential wallet service 434 an encrypted Oauth2 token for the system of record for which the action is to be invoked and may send the action to data integration provider service 432 together with the encrypted Oath2 token. Data integration provider service 432 may then decrypt the Oath2 token and write the action to the appropriate system of record under the identity of user 426. Data integration provider service 432 may then read back changed data from the written-to system of record and send that changed data to microapp service 430. Microapp service 432 may then update active data cache service 436 with the updated data and cause a message to be sent to resource access application 424 (via client interface service 416) notifying user 426 that the action was successfully completed.

In some embodiments, in addition to or in lieu of the functionality described above, resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, resource management services 402 may enable virtual assistance functionality that allows users to remain productive and take quick actions. Users may, for example, interact with the “Virtual Assistant” and ask questions such as “What is Bob Smith's phone number?” or “What absences are pending my approval?” Resource management services 402 may, for example, parse these requests and respond because they are integrated with multiple systems on the backend. In some embodiments, users may be able to interact with the virtual assistance through either resource access application 424 or directly from another resource, such as Microsoft Teams. This feature may allow employees to work efficiently, stay organized, and deliver only the specific information they're looking for.

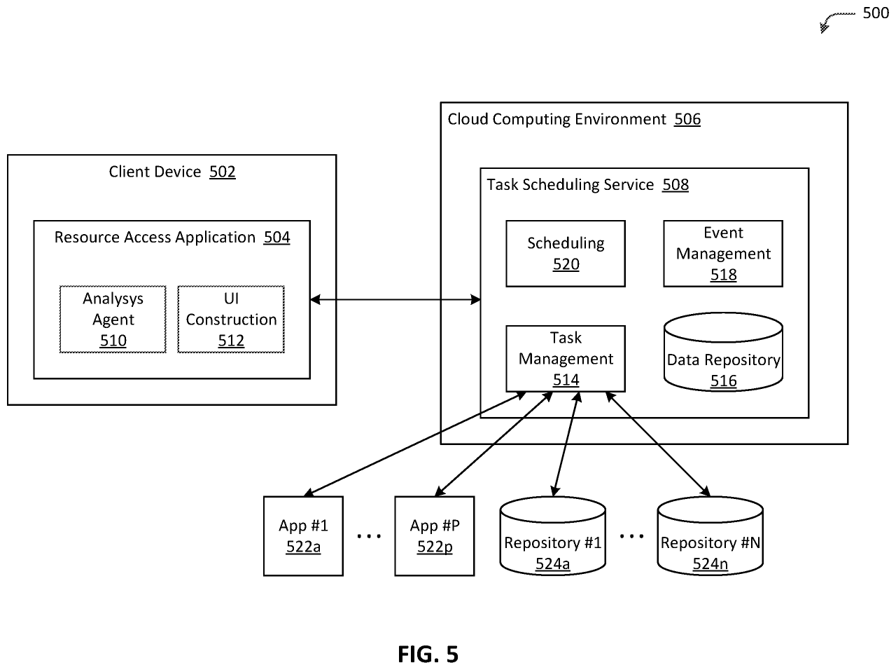

FIG. 5 is a block diagram of an illustrative system 500 for scheduling tasks for completion by a given time, in accordance with an embodiment of the present disclosure. System 500 includes a resource access application 504 installed on a client device 502 and configured to communicate with a cloud computing environment 506 via one or more computer networks. Client device 502, resource access application 504, and cloud computing environment 506 of FIG. 5 can be the same as or similar to client 202, resource access application 424, and cloud computing environment 414, respectively, of FIGS. 4A-4C.

As shown in FIG. 5, a task scheduling service 508 can be provided as a service (e.g., a microservice) within cloud computing environment 506. Resource access application 504 and task scheduling service 508 can interoperate to determine tasks that are assigned to or otherwise associated with a user, determine tasks associated with other users who are associated with the user's tasks, schedule the tasks based on scheduled time off of the user and the other users, and present the scheduled tasks to the user by displaying a scheduling of the tasks on client device 502. A user who is assigned a task and other users identified for performing the task are sometimes referred to herein as “participants of the task” or “participants associated with the task.” In some embodiments, the scheduling may be of tasks associated with participants associated with a task. In some embodiments, the scheduling of a task may be based on periods of time when the participants associated with the task are unavailable and/or time slots for which other tasks associated with the participants associated with the task are scheduled. In some embodiments, the tasks associated with participants associated with a task may be re-scheduled and presented to the user in response to an input (e.g., in response to an activation of a “refresh” button). Additionally or alternatively, the tasks associated with participants associated with a task may be re-scheduled and presented to the user in response to detecting a change to such tasks. In any case, the scheduling of the tasks may be presented to the user to assist the participants associated with the tasks in successfully performing the tasks, for example.

To promote clarity in the drawings, FIG. 5 shows a single resource access application 504 communicably coupled to task scheduling service 508. However, embodiments of task scheduling service 508 can be used to service many resource access applications (e.g., resource access application 504) installed on clients (e.g., client devices 502) associated with one or more organizations and/or users. Resource access application 504 and/or task scheduling service 508 may be implemented as computer instructions executable to perform the corresponding functions disclosed herein. Resource access application 504 and task scheduling service 508 can be logically and/or physically organized into one or more components. In the example of FIG. 5, resource access application 504 includes an analysis agent 510 and a UI construction module 512. Also, in this example, task scheduling service 508 includes a task management module 514, a data repository 516, an event management module 518, and a scheduling module 520.

The client-side resource access application 504 can communicate with the cloud-side task scheduling service 508 using an API. For example, resource access application 504 can send requests (or “messages”) to task scheduling service 508 wherein the requests are received and processed by task scheduling service 508 or one or more components of task scheduling service 508. Likewise, task scheduling service 508 can send responses/messages to resource access application 504 wherein the responses/messages are received and processed by resource access application 504 or one or more components of resource access application 504. In some embodiments, task scheduling service 508 can push information to resource access application 504.

Referring to the client-side resource access application 504, analysis agent 510 and UI construction module 512 can be provided as sub-modules or other components of resource access application 504. Analysis agent 510 is operable to receive a scheduling of tasks from task scheduling service 508. The scheduled tasks may be tasks associated with a particular user (e.g., a user of resource access application 504 on client device 502) as well as other tasks associated with other participants associated with the tasks associated with the particular user. In response to receiving such information, analysis agent 510 can send or otherwise provide the scheduling of tasks and/or information regarding the scheduling and/or the scheduled tasks to UI construction module 512 for presenting on client device 502.

In response to receiving information regarding the scheduling of tasks, UI construction module 512 is operable to visually render/display the scheduled tasks and other information regarding the tasks on client device 502. In more detail, UI construction module 512 can organize the received information regarding the scheduled tasks into a data format that can be rendered/displayed within or as part of a UI, such as a UI of resource access application 504. For example, in one embodiment, UI construction module 512 can organize the information regarding the scheduled tasks using various UI elements that enable a user to view and manage (e.g., access) a schedule for the tasks generated by task scheduling service 108. In one embodiment, the schedule for the tasks may be displayed within a UI provided by a calendaring application and/or an application that provides a calendaring/scheduling service.

Referring to the cloud-side task scheduling service 508, task management module 514 is operable to collect/retrieve information regarding tasks assigned to or otherwise associated with users along with other task-related and user-related information from one or more data sources. The data sources can include, for example, one or more applications 522a-522p (individually referred to herein as application 522 or collectively referred to herein as applications 522) and one or more repositories 524a-524n (individually referred to herein as repository 524 or collectively referred to herein as repositories 524). Applications 522 can include various types of applications such as SaaS applications, web applications, and desktop applications. In some embodiments, applications 522 may correspond to product/project management applications such as WRIKE, JIRA, BASECAMP, and TRELLO. In some embodiments, applications 522 may also correspond to human resource applications such as WORKDAY. In some embodiments, repositories 524 can include various types of data repositories such as conventional file systems, cloud-based storage services such as SHAREFILE, BITBUCKET, DROPBOX, and MICROSOFT ONEDRIVE, and web servers that host files, documents, and other materials.

Task management module 514 may utilize APIs provided by the various data sources to collect/retrieve the items of information therefrom. For example, task management module 514 may use a REST-based API provided by a SaaS application to collect/retrieve the items of information therefrom (e.g., a REST-based API provided by JIRA to retrieve tickets and information about the tickets from JIRA). As another example, task management module 514 may use a REST-based API provided by TRELLO to collect/retrieve tickets and information about the tickets from TRELLO. As still another example, task management module 514 may use an API provided by a human resource application, such as WORKDAY, and/or a product/project management application, such as WRIKE, to collect/retrieve data including information about scheduled time off for a particular user or a group of users. As yet another example, task management module 514 may use a file system interface to collect/retrieve files containing information regarding tasks and/or information regarding scheduled time off of users from a file system. As yet another example, task management module 514 may use an API to download documents containing information regarding tasks and/or information regarding scheduled time off of users from a cloud-based storage service.

A particular data source (e.g., application 522 or repository 524) can be hosted within a cloud computing environment (e.g., cloud computing environment 506 or a different cloud computing environment) or within an on-premises data center (e.g., an on-premises data center of an organization that utilizes task scheduling service 508).

The particular data sources (e.g., applications 522 and repositories 524) from which task management module 514 can collect/retrieve the items of information can vary between different organizations. In some embodiments, task management module 514 can obtain a list of data sources used by a particular organization and/or user. For example, some organizations serviced by task scheduling service 508 may use JIRA as a project management application whereas other organizations may use TRELLO. As another example, some organizations serviced by task scheduling service 508 may use SHAREFILE and BITBUCKET as data repositories whereas other organizations may use MICROSOFT ONEDRIVE. Task management module 514 can determine the particular data sources from which to collect/retrieve the items of information from based on configuration information maintained for the organization and/or user. In some embodiments, task management module 514 may obtain a list of subscribed resources (e.g., applications and services) for a particular organization via resource feed service 420 of FIG. 4B. Task management module 514 may also obtain authentication credentials (e.g., user ids and passwords, access tokens, etc.) which may be needed to access one of more of the data sources for collecting/retrieving the items of information and other data. In some embodiments, task management module 514 may use a single sign-on service (e.g., service 422 of FIG. 4B) to access one or more such data sources.

As mentioned previously, task management module 514 can collect/retrieve information regarding tasks along with other information regarding the tasks from one or more data sources. Such task-related information can include, for a particular task, information such as an identifier (e.g., task id), a user who created the task, a task deadline (e.g., a date or time by which the task is to be completed), a user (i.e., an assignee) to whom the task is assigned, a priority of the task (e.g., an importance of the task), other participants associated with the task (i.e., other users identified for performing the task), scheduled time off of participants associated with the task (i.e., periods of time when the participants associated with the task are unavailable), an estimate of a number of days (e.g., duration) needed to perform the task, a status of the task, and a description of the task. These examples of task information are merely illustrative and may vary depending on the capabilities of the product/project management application(s) and the human resource applications utilized by the organization. Some the task information may be specified by a creator of the task. For example, a creator of a task may specify a user to whom the task is assigned, a task deadline, a priority of the task, and a description of the task. Some of the task information may be specified by a user to whom a task is assigned. For example, an assignee may specify the periods of time when they are unavailable, identify the other participants associated with the task, and specify the estimated number of days needed to perform the task. The other participants associated with the task may specify the periods of time when they are unavailable. Task management module 514 can store the task information collected from the data sources within data repository 516 that can correspond to, for example, a storage service within cloud computing environment 506.

In some embodiments, task management module 514 can collect/retrieve task information from the data sources on a continuous or periodic basis (e.g., according to a predetermined schedule such as, for example, every 30 minutes, 1 hour, 2 hours, or any other suitable period of time). Additionally or alternatively, a data source (e.g., application 522 or repository 524) can send or otherwise provide task information to task management module 514 in response to an event on the data source (e.g., a task being completed, a change in status of a task, a new task being generated, scheduling of time off for a particular user, etc.).

Event management module 518 is configured to initiate the scheduling of tasks associated with a user. In some embodiments, event management module 518 can initiate the scheduling of tasks associated with a user in response to an input. For example, a user of resource access application 504 may click/tap a link or other UI element displayed within a UI of resource access application 504 to access a UI page displaying a schedule for the tasks associated with the user (e.g., display of the scheduled tasks associated with the user within a UI of a calendaring application). In response to such input, resource access application 504 can send a request to task scheduling service 508 that causes event management module 518 to initiate scheduling of the tasks associated with the user. As another example, a user of resource access application 504 may click/tap a “refresh” button in a UI page displaying the schedule for the tasks associated with the user to refresh the display of the scheduled tasks (e.g., to cause the user's tasks to be re-scheduled). In response to such input, resource access application 504 can send a request to task scheduling service 508 that causes event management module 518 to initiate scheduling of the tasks associated with the user. In any case, event management module 518 can send a request to scheduling module 520 that causes scheduling module 520 to schedule the tasks associated with the user.

In some embodiments, event management module 518 can initiate the scheduling of tasks associated with a user in response to determining or detecting a change in the status and/or priority of the tasks associated with the user. For example, event management module 518 may monitor the organization's product/project management application(s) for task status changes (e.g., creation of new tasks, completion of tasks, cancelation of tasks, etc.) or task priority changes. As another example, a product/project management application may send a notification of a task status change or a task priority change to event management module 518. The notification provided by the product/project management application may indicate or otherwise identify the particular task whose status or priority changed. Event management module 518 can determine whether the identified task is a task associated with the user. In response determining a change in the status and/or priority of a task associated with the user, event management module 518 can send a request to scheduling module 520 that causes scheduling module 520 to schedule the tasks associated with the user.

In some embodiments, event management module 518 can initiate the scheduling of tasks associated with a user in response to determining or detecting a change in the scheduled time off of the user. The user's scheduled time off is indicative of the period(s) of time when the user is not available to perform tasks associated with the user. For example, event management module 518 may monitor the organization's human resource application(s) and/or product/project management application(s) for changes to the user's scheduled time off. As another example, a human resource application and/or a product/project management application may send a notification of a change in scheduled time off to event management module 518. The notification provided by the human resource application may indicate or otherwise identify the user whose scheduled time off changed. In response determining a change in the scheduled time off of the user, event management module 518 can send a request to scheduling module 520 that causes scheduling module 520 to schedule the tasks associated with the user.

In some embodiments, event management module 518 can initiate the scheduling of tasks associated with a user in response to determining or detecting a change in the status and/or priority of the tasks associated with participants associated with any task associated with the user. For a given user, it is appreciated that a change in the status or priority of a task associated with any participant associated with any one of the tasks associated with the user may affect the scheduling of the tasks associated with the user. For example, event management module 518 may monitor the organization's product/project management application(s) for task status changes (e.g., creation of new tasks, completion of tasks, cancelation of tasks, etc.) or task priority changes. As another example, a product/project management application may send a notification of a task status change or a task priority change to event management module 518. The notification provided by the product/project management application may indicate or otherwise identify the particular task whose status or priority changed. Event management module 518 can determine whether the identified task is a task associated with a participant associated with any one of the tasks associated with the user. In response determining a change in the status and/or priority of a task associated with a participant associated with any one of the tasks associated with the user, event management module 518 can send a request to scheduling module 520 that causes scheduling module 520 to schedule the tasks associated with the user.

In some embodiments, event management module 518 can initiate the scheduling of tasks associated with a user in response to determining or detecting a change in the scheduled time off of participants associated with any task associated with the user. Similar to the user's scheduled time off, a participant's scheduled time off is indicative of the period(s) of time when the participant is not available to perform tasks associated with the participant. For a given user, it is appreciated that a change in the scheduled time off of any participant associated with any one of the tasks associated with the user may affect the scheduling of the tasks associated with the user. For example, event management module 518 may monitor the organization's human resource application(s) and/or product/project management application(s) for changes to a participant's scheduled time off. As another example, a human resource application and/or a product/project management application may send a notification of a change in scheduled time off to event management module 518. The notification provided by the human resource application may indicate or otherwise identify the user whose scheduled time off changed. Event management module 518 can determine whether the identified user is a participant associated with any one of the tasks associated with the user. In response determining a change in the scheduled time off of a participant associated with any one of the tasks associated with the user, event management module 518 can send a request to scheduling module 520 that causes scheduling module 520 to schedule the tasks associated with the user.

In response to receiving a request to schedule tasks associated with a user, scheduling module 520 can generate a schedule for the tasks associated with the user. In some embodiments, scheduling module 520 can generate a schedule for the tasks by applying a greedy technique which may account for one or more factors such as scheduled time off of participants associated with the tasks, priority of each task, and estimates of durations (e.g., length of time) needed to perform each task, to provide a few examples. The generated schedule for the tasks can then be presented (or “recommended”) to the user so that the user can readily discern when each of the tasks is to be performed.

In some embodiments, scheduling module 520 can schedule a task associated with a user in a manner which accounts for time slots for which other tasks associated with participants associated with the task are scheduled. It is appreciated that the schedule for other tasks may have an impact on (or “influence”) the scheduling of a task which is being currently scheduled. The other tasks may be associated with the user or associated with other participants associated with the task associated with the user and which is being currently scheduled. For a given task, scheduling module 520 may retrieve information regarding the task from data repository 516 and analyze the information to identify the other participants associated with the task (i.e., identify the participants other than the user). Scheduling module 520 can determine the other tasks associated with the user and the other tasks associated with each of the other participants associated with the task which is being currently scheduled. Scheduling module 520 can then determine candidate time slots for scheduling the task based on the time slots for which the determined other tasks are scheduled and schedule the task to be performed in one of the candidate time slots. In some embodiments, the determined candidate time slots are time slots which do not conflict with any of the time slots for which the other tasks are scheduled (e.g., a candidate time slot does not overlap any portion of any of the time slots for which the other tasks are scheduled). Scheduling module 520 can schedule other tasks that are associated with the user and that need to be scheduled in a similar manner.

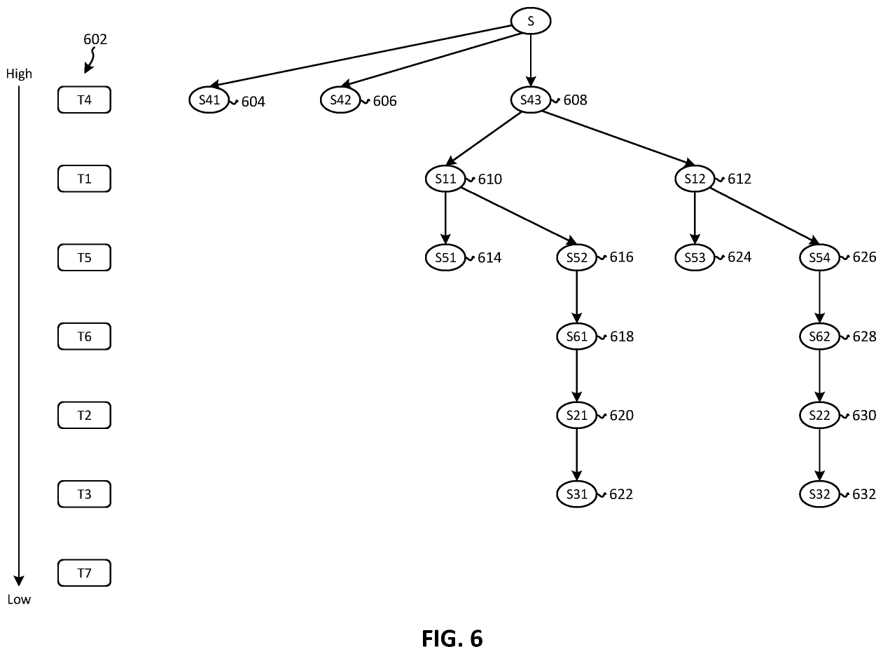

In some embodiments, scheduling module 520 can schedule a task associated with a user in a manner which additionally or alternatively accounts for periods of time participants associated with the task are unavailable. As explained previously, the participants associated with the task include both the user who is associated with the task and the other participants associated with the task. Scheduling module 520 may retrieve information regarding periods of time the participants associated with the task are unavailable (i.e., the scheduled time off of the participants associated with the task) from data repository 516. Scheduling module 520 can then determine candidate time slots for scheduling the task based on the periods of time when the participants associated with the task are unavailable and schedule the task to be performed in one of the candidate time slots. In some embodiments, the determined candidate time slots are time slots which do not conflict with any of the periods of time when the participants associated with the task are unavailable (e.g., a candidate time slot does not overlap any portion of any of the periods of time when the participants associated with the task are unavailable). Scheduling module 520 can schedule other tasks that are associated with the user and that need to be scheduled in a similar manner. Further description of the scheduling of tasks associated with a user and other processing that can be implemented within scheduling module 520 is further described below at least with respect to FIGS. 6-9R.

When scheduling the tasks that need to be scheduled, scheduling module 520 may implement various scheduling rules/techniques to determine an order in which scheduling module 520 is to attempt the scheduling of different ones of the tasks. In some embodiments, one scheduling rule/technique may be to schedule the tasks based on a number of participants associated with the individual tasks. Applying such a rule/technique, scheduling module 520 may attempt to schedule a task which is associated with a larger number of participants before attempting to schedule a task which is associated with a smaller number of participants. For example, suppose Task A, Task B, and Task C need to be scheduled. Also suppose that two participants are associated with Task A, five participants are associated with Task B, and three participants are associated with Task C. In this example, scheduling module 520 can attempt to first schedule Task B which is associated with the largest number of participants (e.g., associated with five participants), then attempt to schedule Task C which is associated with the second largest number of participants (e.g., associated with three participants), and then finally attempt to schedule Task A which is associated with the smallest number of participants (e.g., associated with two participants).

In some embodiments, one scheduling rule/technique may be to schedule the tasks based on a priority of a task in cases where two or more tasks (i.e., multiple tasks) that need to be scheduled are associated with the same number of participants. Applying such a rule/technique, scheduling module 520 may schedule a task which has a higher priority before scheduling a task which with a lower priority. For example, in the example above, suppose that there is also a Task D that needs to be scheduled and two participants are associated with Task D. Also suppose that Task D has a higher priority than Task A which is also associated with two participants (i.e., Task A and Task D are associated with the same number of participants). In this example, scheduling module 520 can attempt to first schedule Task B which is associated with the largest number of participants (e.g., associated with five participants), then attempt to schedule Task C which is associated with the second largest number of participants (e.g., associated with three participants), then attempt to schedule Task D which is associated with the smallest number of participants (e.g., associated with two participants) but has a higher priority than Task A, and then finally attempt to schedule Task A which is associated with the smallest number of participants (e.g., associated with two participants) but which has a lower priority than Task D.

In some embodiments, scheduling module 520 may generate a schedule for tasks associated with a user and which have task deadlines that are within a predetermined time period. In other words, the tasks that need to be scheduled by scheduling module 520 may include the tasks that have task deadlines that are within a predetermined period of time. The predetermined time period may be a project or program iteration, such as 2 weeks, 4 weeks, or 6 weeks, during which tasks are performed to achieve a goal (e.g., a duration during which development takes place). The predetermined time period may be defined by the organization and/or the user. The predetermined time period can vary between different organizations and/or users.

FIG. 6 is a diagram of a graph illustrating a scheduling of tasks by application of a greedy technique, in accordance with an embodiment of the present disclosure. For example, with continued reference to FIG. 5, the scheduling of the tasks may be performed by scheduling module 520 based on task-related information collected and stored within data repository 516. The scheduling may be initiated by event management module 518.

In the example of FIG. 6, scheduling module 520 may be scheduling tasks T1-T7. For example, tasks T1-T7 may include both tasks that are associated with a particular user and other tasks associated with other participants associated with the tasks associated with the particular user. As alluded to previously, the other participants and the schedules for the other participants' tasks may have an impact on the scheduling of the tasks associated with the particular user. To schedule tasks T1-T7, scheduling module 520 may first sort (or “order”) the tasks by applying scheduling rules/techniques which may be applicable. Based on the applicable rules/techniques, scheduling module 520 may sort the tasks for scheduling in a task list as follows (e.g., in descending order): T4, T1, T5, T6, T2, T3, T7. See reference numeral 602 in FIG. 6.

Continuing the example of FIG. 6, scheduling module 520 may attempt to schedule the first task, T4, which needs to be scheduled in the task list, and determine that there are three candidate time slots, S41, S42, S43, suitable for scheduling task T4. See reference numerals 604, 606, 608 in FIG. 6. Applying the greedy technique, scheduling module 520 can schedule task T4 for candidate time slot S41 (e.g., schedule task T4 for the first available candidate time slot).

Next, scheduling module 520 may attempt to schedule the next task, T1, which needs to be scheduled in the task list. In the example of FIG. 6, scheduling module 520 may determine that there are no candidate time slots suitable for scheduling task T1 given the scheduling of task T4 for candidate time slot S41. Since no candidate timeslots are found for task T1, scheduling module 520 may determine whether there is a scheduled task available to reschedule. For example, scheduling module 520 may reschedule a scheduled task in an effort to find a candidate time slot for a task which is being currently scheduled (e.g., task T1). At this stage in the scheduling of the tasks in the task list (e.g., task T4 is scheduled for candidate time slot S41), scheduling module 520 may determine that task T4 can be rescheduled since there are two other candidate time slots, S42 and S43, suitable for scheduling task T4. In other words, there are other candidate time slots, S42 and S43, which are suitable for scheduling task T4 and which have not yet been tried for scheduling task T4. Based on this determination, scheduling module 520 can deschedule the scheduling of task T4 for candidate time slot S41 (i.e., no longer schedule task T4 for candidate time slot S41) and reschedule task T4 for candidate time slot S42.

Upon rescheduling task T4 for candidate time slot S42, scheduling module 520 may again attempt to schedule task T1 (i.e., attempt to schedule the next task which needs to be scheduled in the task list). In the example of FIG. 6, scheduling module 520 may determine that there are no candidate time slots suitable for scheduling task T1 given the scheduling of task T4 for candidate time slot S42. Since no candidate timeslots are found for task T1, scheduling module 520 may determine whether there is a scheduled task available to reschedule. At this stage in the scheduling of the tasks in the task list (e.g., task T4 is scheduled for candidate time slot S42), scheduling module 520 may determine that task T4 can be rescheduled since there is another candidate time slot, S43, suitable for scheduling task T4. Note that candidate time slot S41 is no longer a viable time slot since it has already been tried for scheduling task T4. Based on this determination, scheduling module 520 can deschedule the scheduling of task T4 for candidate time slot S42 (i.e., no longer schedule task T4 for candidate time slot S42) and reschedule task T4 for candidate time slot S43.

Upon rescheduling task T4 for candidate time slot S43, scheduling module 520 may again attempt to schedule task T1. In the example of FIG. 6, scheduling module 520 may determine that there are two candidate time slots, S11 and S12, suitable for scheduling task T1. See reference numerals 610, 612 in FIG. 6. Applying the greedy technique, scheduling module 520 can schedule task T1 for candidate time slot S11 (e.g., schedule task T1 for the first available candidate time slot).

Next, scheduling module 520 may attempt to schedule the next task, T5, which needs to be scheduled in the task list. In the example of FIG. 6, scheduling module 520 may determine that there are two candidate time slots, S51, S52, suitable for scheduling task T5 at this stage in the scheduling of the tasks in the task list (e.g., task T4 scheduled for candidate time slot S43 and task T1 scheduled for candidate time slot S11). See reference numerals 614, 616 in FIG. 6. Applying the greedy technique, scheduling module 520 can schedule task T5 for candidate time slot S51 (e.g., schedule task T5 for the first available candidate time slot).

Next, scheduling module 520 may attempt to schedule the next task, T6, which needs to be scheduled in the task list. In the example of FIG. 6, scheduling module 520 may determine that there are no candidate time slots suitable for scheduling task T6 at this stage in the scheduling of the tasks in the task list (e.g., task T4 scheduled for candidate time slot S43, task T1 scheduled for candidate time slot S11, and task T5 scheduled for candidate time slot S51). Since no candidate timeslots are found for task T6, scheduling module 520 may determine whether there is a scheduled task available to reschedule. At this stage in the scheduling of the tasks in the task list, scheduling module 520 may determine that tasks T5 and T1 can be rescheduled since there are other candidate time slots suitable for scheduling task T5 and Task T1. In particular, task T5 can be rescheduled since there is another candidate time slot, S52, suitable for scheduling task T5, and task T1 can be rescheduled since there is another candidate time slot, S12, suitable for scheduling task T1. In some embodiments, in cases where there are two or more tasks which can be rescheduled, based on application of the greedy technique, the most recently scheduled task of the multiple tasks which can be rescheduled may be selected for rescheduling. In other words, the scheduled task in the task list which is closest to the task which is being currently scheduled may be selected for rescheduling. In the example of FIG. 6, applying the greedy technique, scheduling module 520 can select task T5 for rescheduling and deschedule the scheduling of task T5 for candidate time slot S51 (i.e., no longer schedule task T5 for candidate time slot S51). Upon descheduling task T5, scheduling module 520 can reschedule task T5 for candidate time slot S52 (e.g., reschedule task T5 for the first available candidate time slot). Selecting the most recently scheduled task that is available for rescheduling reduces, and ideally minimizes, the number of intervening tasks (i.e., the tasks which were scheduled after the scheduling of task which is being currently scheduled) which also need to be descheduled and rescheduled along with the selected task for rescheduling. Note that the intervening task(s) are descheduled since the schedule for these tasks may impact the rescheduling of the task selected for rescheduling. Reducing the number of scheduled tasks that are descheduled and rescheduled can reduce resource usage by the computing device on which schedule module 520 is executing to perform the scheduling of the tasks in the task list.

Upon rescheduling task T5 for candidate time slot S52, scheduling module 520 may again attempt to schedule task T6. In the example of FIG. 6, scheduling module 520 may determine that there is one candidate time slot, S61, suitable for scheduling task T6 at this stage in the scheduling of the tasks in the task list (e.g., task T4 scheduled for candidate time slot S43, task T1 scheduled for candidate time slot S11, and task T5 scheduled for candidate time slot S52). See reference numeral 618 in FIG. 6. Applying the greedy technique, scheduling module 520 can schedule task T6 for candidate time slot S61 (e.g., schedule task T6 for the first available candidate time slot).

Next, scheduling module 520 may attempt to schedule the next task, T2, which needs to be scheduled in the task list. In the example of FIG. 6, scheduling module 520 may determine that there is one candidate time slot, S21, suitable for scheduling task T2 at this stage in the scheduling of the tasks in the task list (e.g., task T4 scheduled for candidate time slot S43, task T1 scheduled for candidate time slot S11, task T5 scheduled for candidate time slot S52, and task T6 scheduled for candidate time slot S61). See reference numeral 620 in FIG. 6. Applying the greedy technique, scheduling module 520 can schedule task T2 for candidate time slot S21 (e.g., schedule task T2 for the first available candidate time slot).

Next, scheduling module 520 may attempt to schedule the next task, T3, which needs to be scheduled in the task list. In the example of FIG. 6, scheduling module 520 may determine that there is one candidate time slot, S31, suitable for scheduling task T3 at this stage in the scheduling of the tasks in the task list (e.g., task T4 scheduled for candidate time slot S43, task T1 scheduled for candidate time slot S11, task T5 scheduled for candidate time slot S52, task T6 scheduled for candidate time slot S61, and task T2 scheduled for candidate time slot S21). See reference numeral 622 in FIG. 6. Applying the greedy technique, scheduling module 520 can schedule task T3 for candidate time slot S31 (e.g., schedule task T3 for the first available candidate time slot).

Next, scheduling module 520 may attempt to schedule the next task, T7, which needs to be scheduled in the task list. In the example of FIG. 6, scheduling module 520 may determine that there are no candidate time slots suitable for scheduling task T7 at this stage in the scheduling of the tasks in the task list (e.g., task T4 scheduled for candidate time slot S43, task T1 scheduled for candidate time slot S11, task T5 scheduled for candidate time slot S52, task T6 scheduled for candidate time slot S61, task T2 scheduled for candidate time slot S21, and task T3 scheduled for candidate time slot S31). Since no candidate timeslots are found for task T7, scheduling module 520 may determine whether there is a scheduled task available to reschedule. At this stage in the scheduling of the tasks in the task list, scheduling module 520 may determine that task T1 can be rescheduled since there is another candidate time slot, S12, suitable for scheduling task T1. Note that tasks T5, T6, T2, T3, which were scheduled after the scheduling of task T1 are not available for rescheduling since there are no other candidate time slots suitable for scheduling any of tasks T5, T6, T2, T3. Based on this determination, applying the greedy technique, scheduling module 520 can deschedule the scheduling of task T1 for candidate time slot S11 (i.e., no longer schedule task T1 for candidate time slot S11) and reschedule task T1 for candidate time slot S12 (e.g., schedule task T1 for the first available candidate time slot). Scheduling module 520 can also deschedule the scheduling of tasks T5, T6, T2, T3, since these tasks were scheduled after the scheduling of the rescheduled task T1 (i.e., tasks T5, T6, T2, T3 are the intervening tasks which were scheduled after the scheduling of task T1). As such, descheduled tasks T5, T6, T2, T3 are no longer scheduled and are rescheduled by scheduling module 520.

Upon rescheduling task T1 for candidate time slot S12, scheduling module 520 schedule the next task, T5, which needs to be scheduled in the task list. As explained above, scheduling module 520 reschedules task T5 since it was one of the tasks which was descheduled. In the example of FIG. 6, scheduling module 520 may determine that there are two candidate time slots, S53, S54, suitable for scheduling task T5 at this stage in the scheduling of the tasks in the task list (e.g., task T4 scheduled for candidate time slot S43 and task T1 scheduled for candidate time slot S12). See reference numerals 624, 626 in FIG. 6. Applying the greedy technique, scheduling module 520 can schedule task T5 for candidate time slot S53 (e.g., schedule task T5 for the first available candidate time slot).

Next, scheduling module 520 may attempt to schedule the next task, T6, which needs to be scheduled in the task list. In the example of FIG. 6, scheduling module 520 may determine that there are no candidate time slots suitable for scheduling task T6 at this stage in the scheduling of the tasks in the task list (e.g., task T4 scheduled for candidate time slot S43, task T1 scheduled for candidate time slot S12, and task T5 scheduled for candidate time slot S53). Since no candidate timeslots are found for task T6, scheduling module 520 may determine whether there is a scheduled task available to reschedule. At this stage in the scheduling of the tasks in the task list, scheduling module 520 may determine that task T5 can be rescheduled since there is another candidate time slot, S54, suitable for scheduling task T5. Based on this determination, scheduling module 520 can deschedule the scheduling of task T5 for candidate time slot S53 (i.e., no longer schedule task T5 for candidate time slot S53) and reschedule task T5 for candidate time slot S54.

Upon rescheduling task T5 for candidate time slot S54, scheduling module 520 may again attempt to schedule task T6. In the example of FIG. 6, scheduling module 520 may determine that there is one candidate time slot, S62, suitable for scheduling task T6 at this stage in the scheduling of the tasks in the task list (e.g., task T4 scheduled for candidate time slot S43, task T1 scheduled for candidate time slot S12, and task T5 scheduled for candidate time slot S54). See reference numeral 628 in FIG. 6. Applying the greedy technique, scheduling module 520 can schedule task T6 for candidate time slot S62 (e.g., schedule task T6 for the first available candidate time slot).

Next, scheduling module 520 may attempt to schedule the next task, T2, which needs to be scheduled in the task list. In the example of FIG. 6, scheduling module 520 may determine that there is one candidate time slot, S22, suitable for scheduling task T2 at this stage in the scheduling of the tasks in the task list (e.g., task T4 scheduled for candidate time slot S43, task T1 scheduled for candidate time slot S12, task T5 scheduled for candidate time slot S54, and task T6 scheduled for candidate time slot S62). See reference numeral 630 in FIG. 6. Applying the greedy technique, scheduling module 520 can schedule task T2 for candidate time slot S22 (e.g., schedule task T2 for the first available candidate time slot).

Next, scheduling module 520 may attempt to schedule the next task, T3, which needs to be scheduled in the task list. In the example of FIG. 6, scheduling module 520 may determine that there is one candidate time slot, S32, suitable for scheduling task T3 at this stage in the scheduling of the tasks in the task list (e.g., task T4 scheduled for candidate time slot S43, task T1 scheduled for candidate time slot S12, task T5 scheduled for candidate time slot S54, task T6 scheduled for candidate time slot S62, and task T2 scheduled for candidate time slot S22). See reference numeral 632 in FIG. 6. Applying the greedy technique, scheduling module 520 can schedule task T3 for candidate time slot S32 (e.g., schedule task T3 for the first available candidate time slot).

Next, scheduling module 520 may attempt to schedule the next task, T7, which needs to be scheduled in the task list. In the example of FIG. 6, scheduling module 520 may determine that there are no candidate time slots suitable for scheduling task T7 at this stage in the scheduling of the tasks in the task list (e.g., task T4 scheduled for candidate time slot S43, task T1 scheduled for candidate time slot S12, task T5 scheduled for candidate time slot S54, task T6 scheduled for candidate time slot S62, task T2 scheduled for candidate time slot S22, and task T3 scheduled for candidate time slot S32). Since no candidate timeslots are found for task T7, scheduling module 520 may determine whether there is a scheduled task available to reschedule. At this stage in the scheduling of the tasks in the task list, scheduling module 520 may determine that there is no scheduled task available to reschedule. In other words, currently scheduled tasks T4, T1, T5, T6, T2, T3 are not available to reschedule since there are no candidate time slots suitable for rescheduling any of tasks T4, T1, T5, T6, T2, T3. As a result, scheduling module 520 can determine that task T7 is not schedulable (i.e., task T7 is not scheduled).

Upon determining that task T7, which is the task that is being currently scheduled, is not schedulable, scheduling module 520 may attempt to schedule the next task which needs to be scheduled in the task list. In the example of FIG. 6, scheduling module 520 can determine that it has processed the tasks that need to be scheduled since task T7 is the last task in the task list. In other words, scheduling module 520 has attempted to schedule all the tasks in the task list. At this stage, scheduling module 520 has generated a schedule for the tasks in the task list (i.e., generated a schedule for tasks T1-T7).

Upon generating a schedule for the tasks in the task list, in some embodiments, scheduling module 520 may send (or “transmit”) information regarding the scheduling of tasks T1-T7 to a client device and, in response, the client device may present the generated schedule for tasks T1-T7 (e.g., display the schedule for tasks T1-T7 within a UI of an application running on the client device).

In some embodiments, scheduling module 520 may revise or alter a task that is not schedulable and attempt to schedule the task in its revised form. For example, on one such embodiment, scheduling module 520 may determine which of the participants associated with such a task is the least relevant (or “least important”) to performing the task. Scheduling module 520 may remove the determined least relevant participant (i.e., no longer associate the least important participant with the task). Scheduling module 520 may then attempt to schedule the task with the determined least relevant participant no longer associated with the task. Scheduling module 520 may be able to successfully schedule the task since the removed participant does not impact the scheduling of the task.

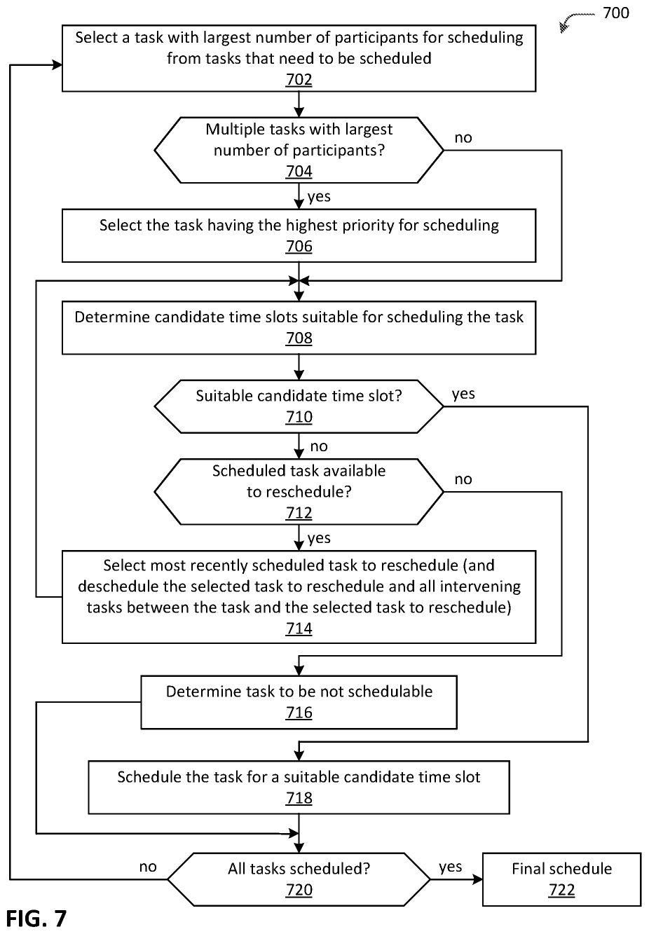

FIG. 7 is a flow diagram of an illustrative process 700 for scheduling tasks, in accordance with an embodiment of the present disclosure. Illustrative process 700 may be implemented, for example, within a cloud computing service, such as task scheduling service 508 of FIG. 5. In the example of FIG. 7 and in the following description thereof, it is assumed that a scheduling module (e.g., scheduling module 520) is generating a schedule for tasks associated with a user U1. As explained above, other participants associated with the tasks associated with user U1 may impact the scheduling of the tasks associated with user U1.

TABLE 1

| Task Id | Duration | Participants (Number) | Task Priority |
|---|---|---|---|
| T1 | 4 days | U3, U4, U5 (3) | 2 (lower number is |
| | | | higher priority) |
| T2 | 4 days | U6, U7 (2) | 3 |
| T3 | 4 days | U1, U2 (2) | 4 |
| T4 | 3 days | U1, U2, U3, U4, U5, | 1 |
| | | U6, U7 (7) | |
| T5 | 1 day | U1, U2, U3 (3) | 5 |
| T6 | 1 day | U2, U4, U5 (3) | 6 |
| T7 | 1 day | U6, U7 (2) | 7 |

Table 1 shows a simplified example of the tasks that need to be scheduled in order to schedule the tasks associated with user U1. In this example, as shown in Table 1, tasks T1-T7 are the tasks which need to be scheduled. In some embodiments, tasks T1-T7 may be the same as or similar to tasks T1-T7 shown in FIG. 6 and described above in the context thereof. In this example, it is assumed that tasks T1-T7 may be the tasks which have task deadlines that are within a predetermined time period (e.g., time period from February 6 to February 19). In this example, it is also assumed that weekend days (i.e., Saturdays and Sundays) are not suitable for scheduling a task. In other words, a candidate time slot for scheduling a task cannot include a Saturday or a Sunday.

In the example of Table 1, three users, U3, U4, U5, are participants associated with task T1, two users, U6, U7, are participants associated with task T2, two users, U1, U2, are participants associated with task T3, seven users, U1, U2, U3, U4, U5, U6, U7, are participants associated with task T4, three users, U1, U2, U3, are participants associated with task T5, three users, U2, U4, U5, are participants associated with task T6, and two users, U6, U7, are participants associated with task T7. Thus, user U1 is a participant of tasks T3, T4, T5, user U2 is a participant of tasks T3, T4, T5, T6, user U3 is a participant of tasks T1, T4, T5, user U4 is a participant of tasks T1, T4, T6, user U5 is a participant of tasks T1, T4, T6, user U6 is a participant of tasks T2, T4, T7, and user U7 is a participant of tasks T2, T4, T7.

In this example, as also shown in Table 1, task T1 is estimated to take a duration of 4 days to perform, task T2 is estimated to take a duration of 4 days to perform, task T3 is estimated to take a duration of 4 days to perform, task T4 is estimated to take a duration of 3 days to perform, task T5 is estimated to take a duration of 1 day to perform, task T6 is estimated to take a duration of 1 day to perform, and task T7 is estimated to take a duration of 1 day to perform. Task T4 may have the highest priority, followed by, in descending priority, tasks T1, T2, T3, T5, and T6, and task T7 may have the lowest priority.

As shown in Table 2 below, users U1, U2, U3 may each have scheduled time off for February 18, users U4, U5 may each have scheduled time off for February 17, user U6 may have scheduled time off for February 7 and February 18, and user U7 may have scheduled time off for February 7 and February 17. In other words, users U1, U2, U3 are unavailable on February 18, users U4, U5 are unavailable on February 17, user U6 is unavailable on February 7 and February 18, and user U7 is unavailable on February 7 and February 17.

TABLE 2

| | Scheduled Time Off |
|---|---|
| Participant | (periods of time unavailable) |
| U1 | Feb 18 |
| U2 | Feb 18 |
| U3 | Feb 18 |
| U4 | Feb 17 |
| U5 | Feb 17 |
| U6 | Feb 7, Feb 18 |
| U7 | Feb 7, Feb 17 |

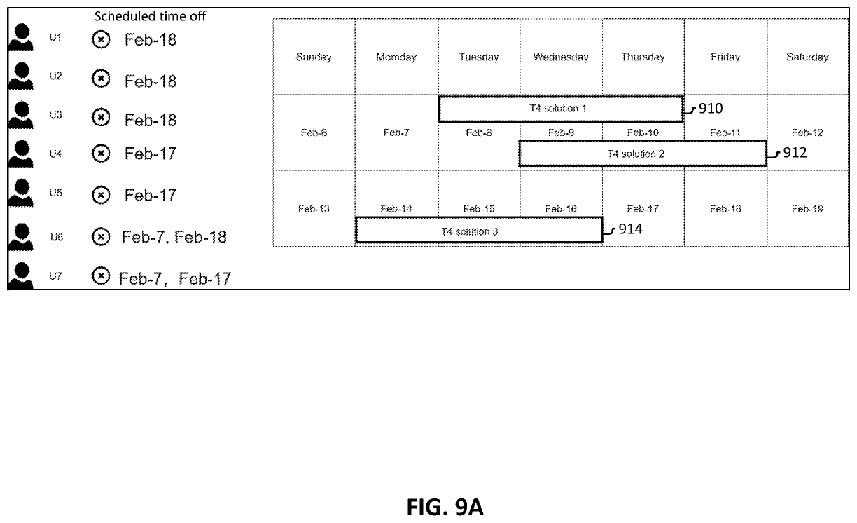

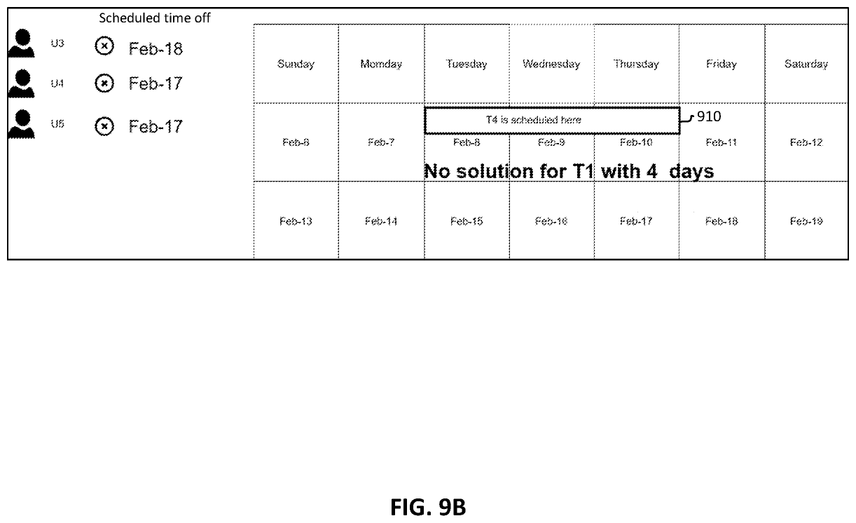

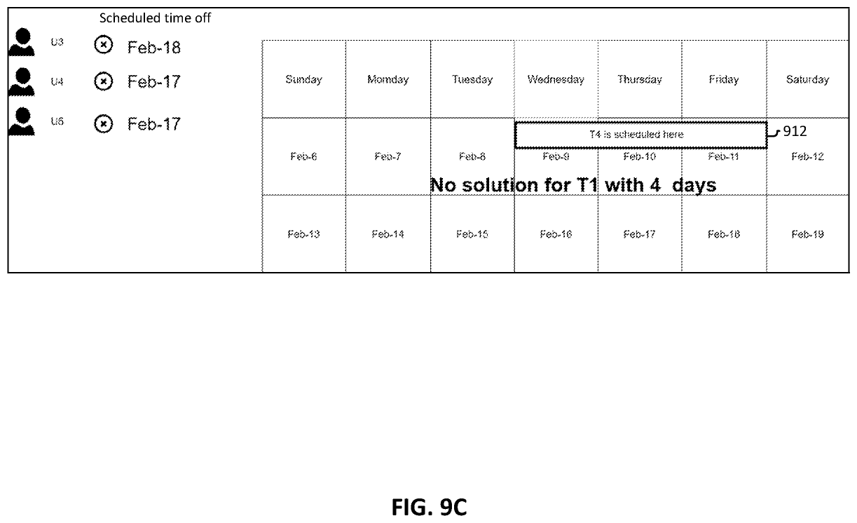

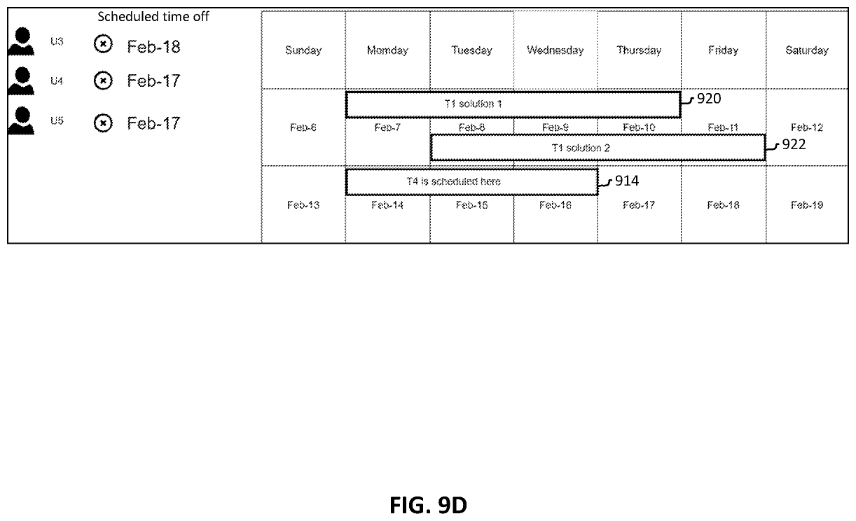

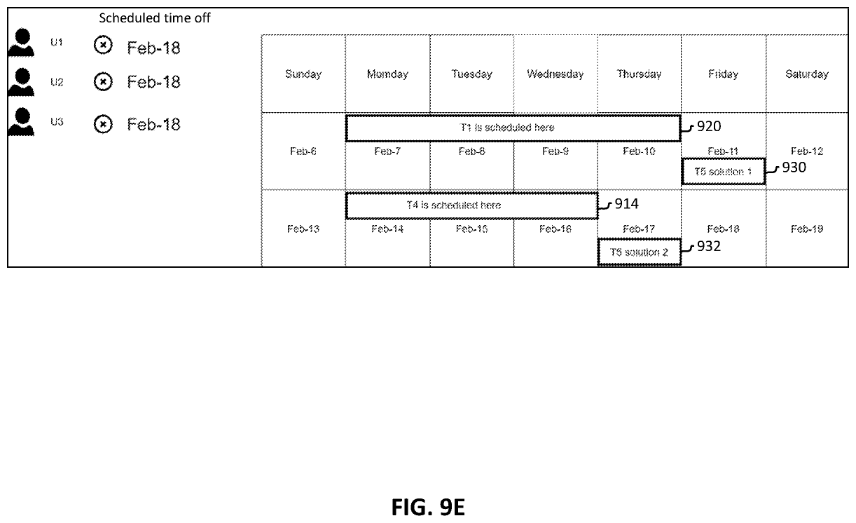

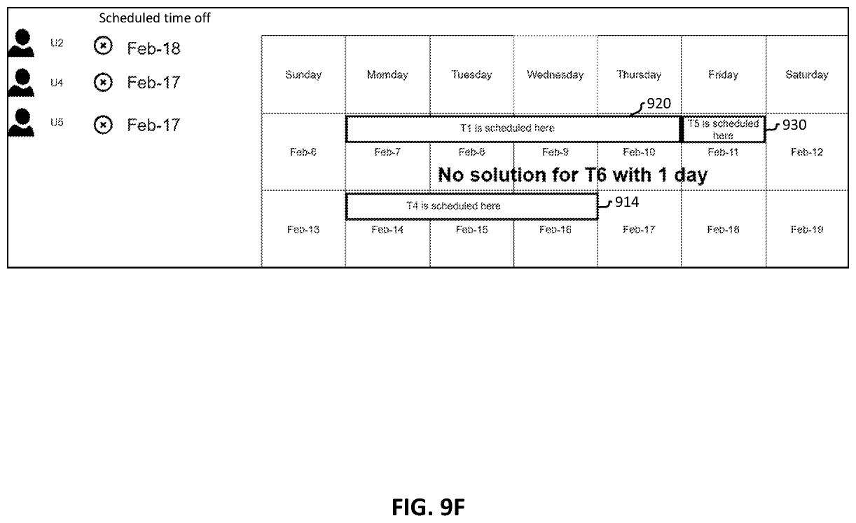

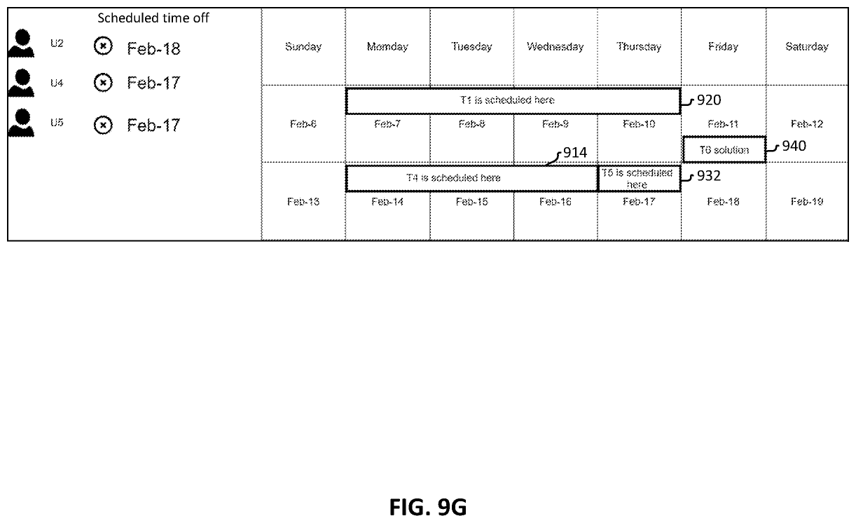

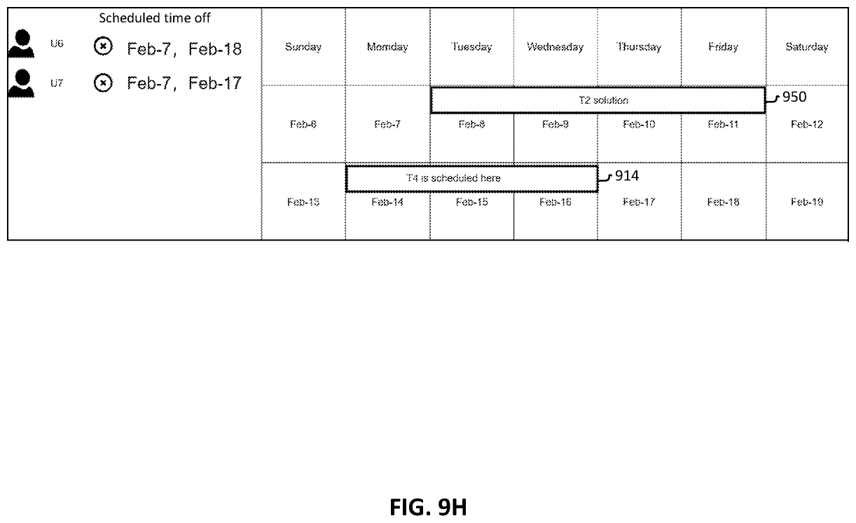

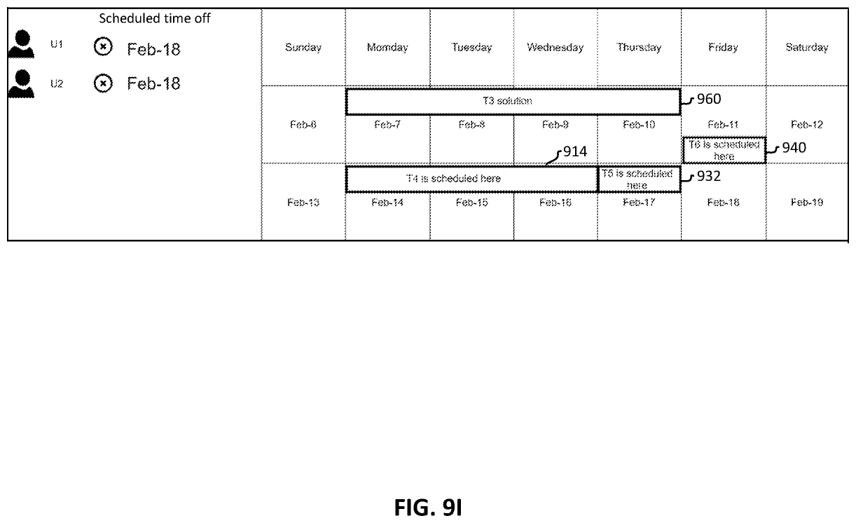

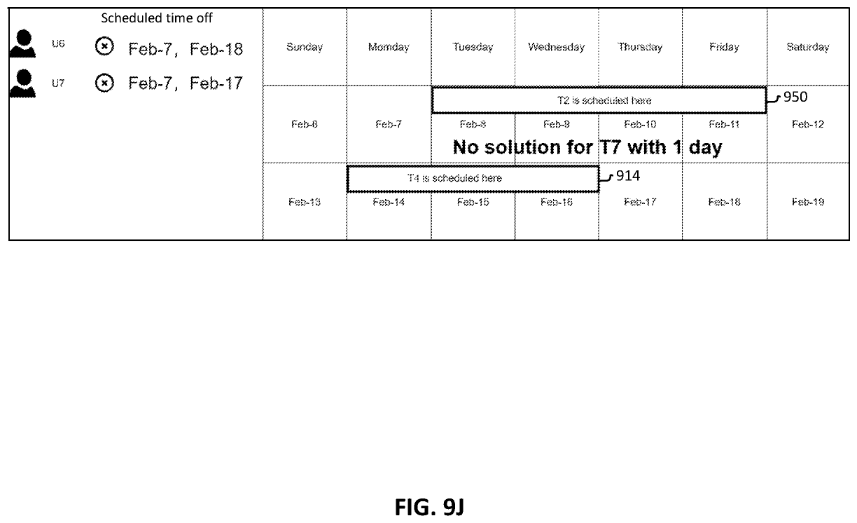

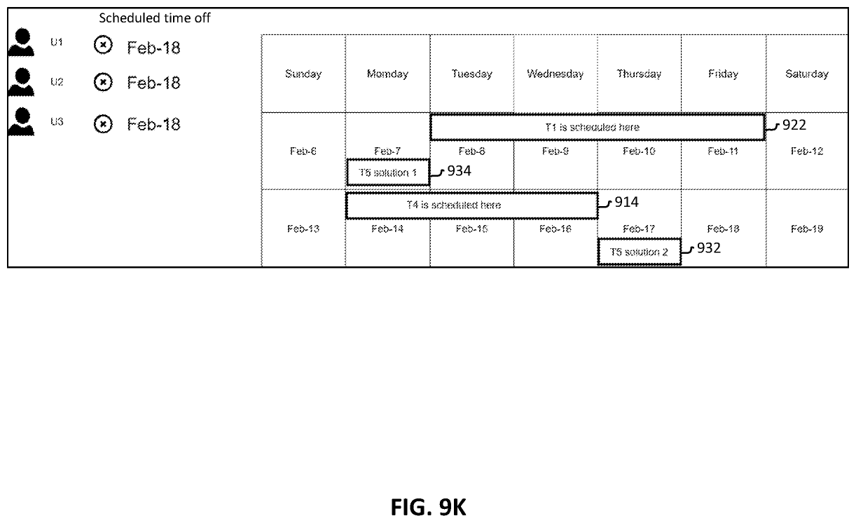

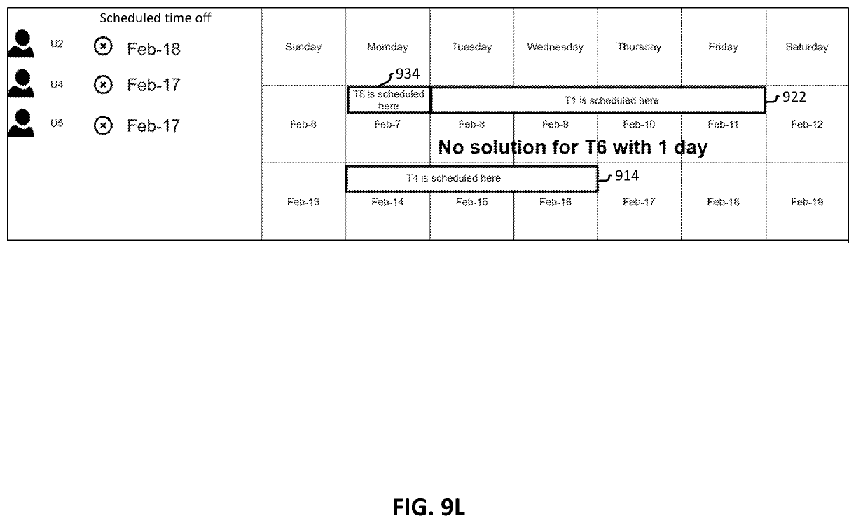

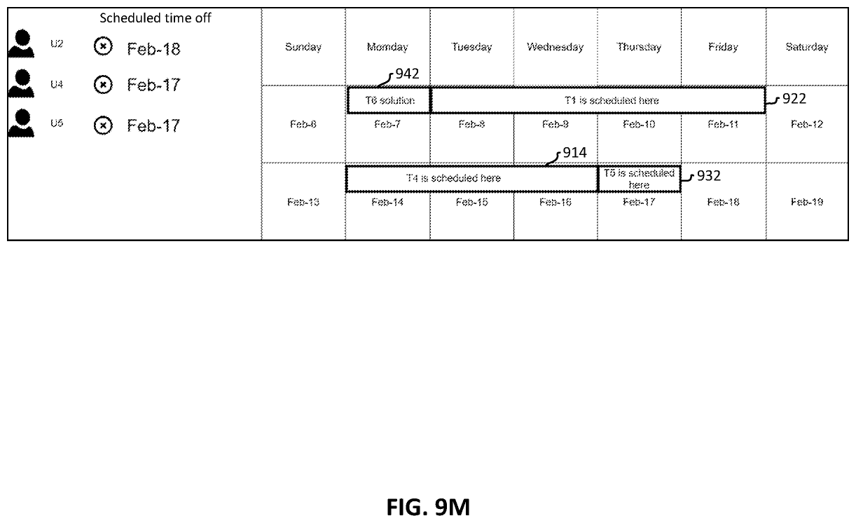

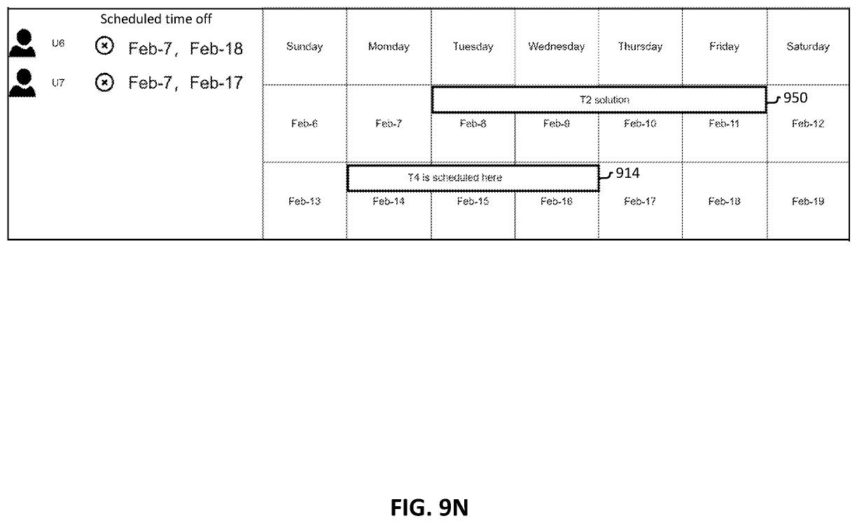

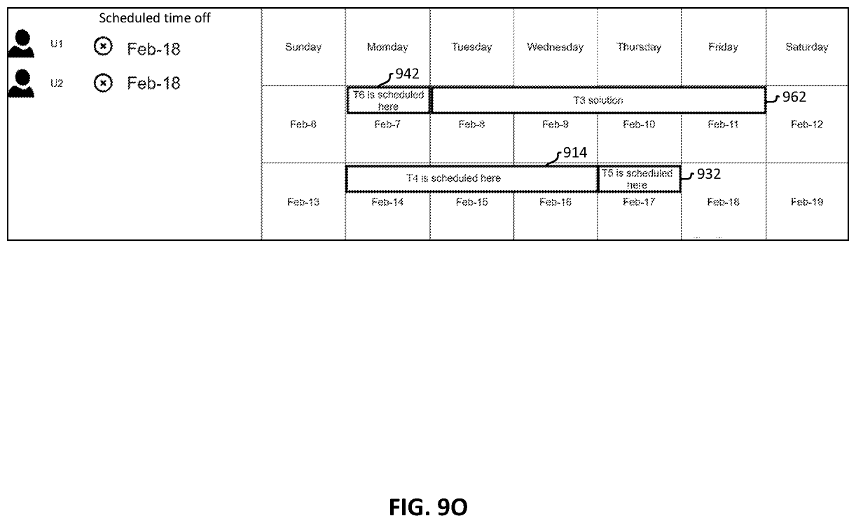

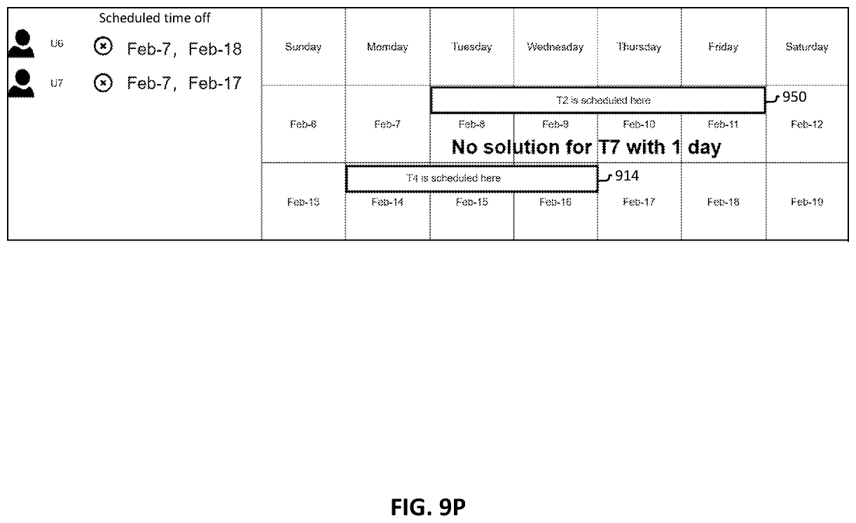

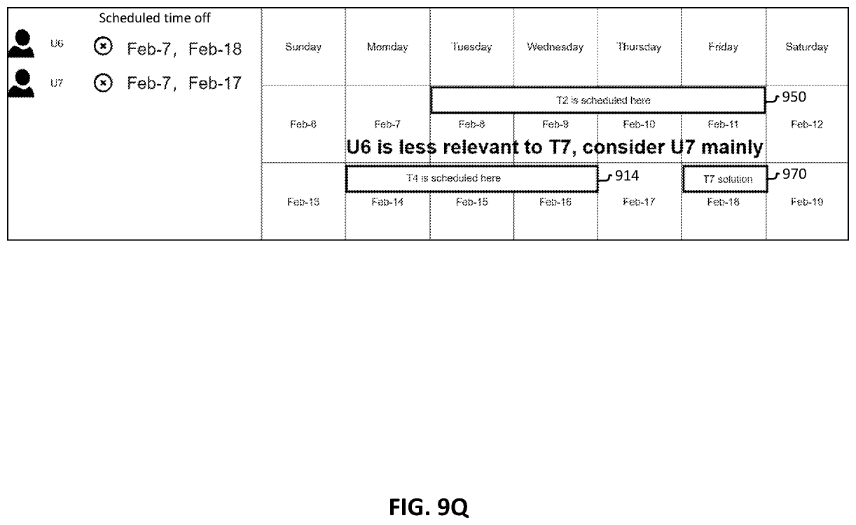

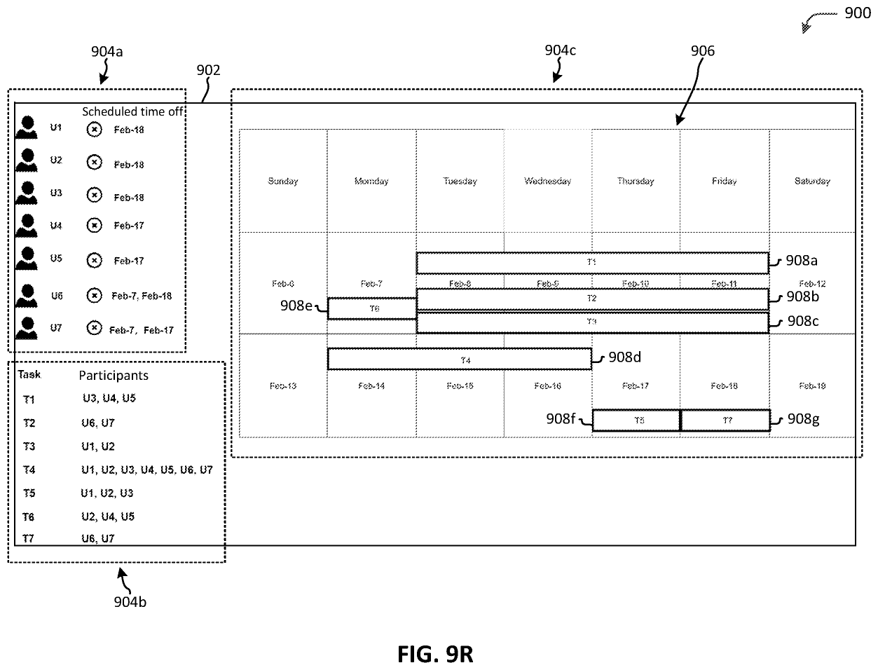

Referring to illustrative process 700, process 700 will be described with reference to the example UIs illustrated in FIGS. 9A-9R. Note that the UIs illustrated in FIGS. 9A-9Q show the scheduling of the tasks T1-T7 at various stages of the scheduling process and are included to aid in the discussion of the example of Tables 1 and 2.

At 702, a task with the largest number of participants can be selected for scheduling from the tasks that need to be scheduled. In the example of Tables 1 and 2, task T4 can be selected for scheduling since it has the largest number of participants (i.e., seven participants are associated with task T4) among the tasks that need to be scheduled.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, there is one task, task T4, with the largest number of participants.

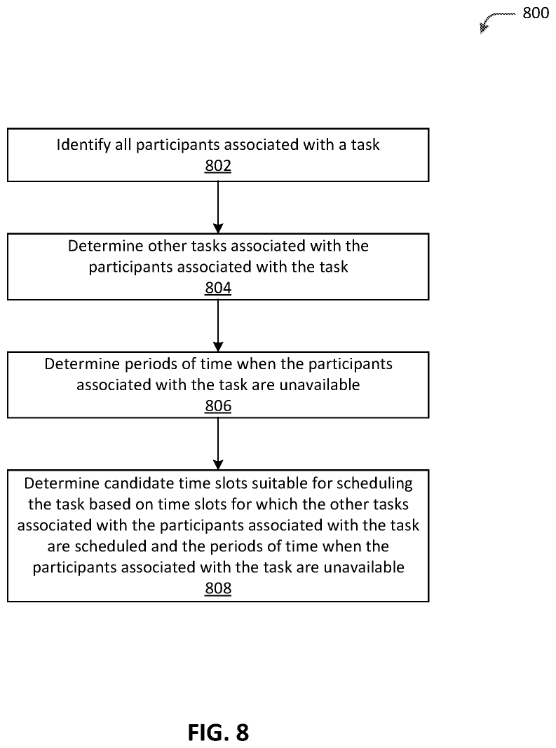

At 708, candidate time slots suitable for scheduling the task can be determined. Further description of processing that can be performed to determine candidate time slots suitable for scheduling a task is provided below with respect to FIG. 8. In the example of Tables 1 and 2, there are three candidate time slots between February 6 to February 19 suitable for scheduling task T4. As shown in FIG. 9A, a candidate time slot 910 suitable for scheduling task T4 may be from February 8 to February 10, a candidate time slot 912 suitable for scheduling task T4 may be from February 9 to February 11, and a candidate time slot 914 suitable for scheduling task T4 may be from February 14 to February 16. Note that there are no other time slots of duration 3 days in which all the participants, users U1, U2, U3, U4, U5, U6, U7, associated with task T4 are available for performing task T4.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T4 can be scheduled for candidate time slot 910.

Upon scheduling the task, at 720, a check can be made to determine whether all tasks that need to be scheduled have been scheduled or attempted to be scheduled. If all the tasks have been scheduled or attempted to be scheduled, then, at 722, it can be determined that a final schedule for the tasks that need to be scheduled have been generated.

Otherwise, if all the tasks have not been scheduled or attempted to be scheduled (i.e., there are other tasks which need to be scheduled), then, at 702, a task with the largest number of participants can be selected for scheduling from the tasks that need to be scheduled. In other words, a next task to schedule can be selected from the tasks that need to be scheduled. In the example of Tables 1 and 2, tasks T1, T5, T6 can be selected for scheduling since they have the largest number of participants (i.e., three participants are associated with each of tasks T1, T5, T6) among the tasks that need to be scheduled. Note that at this stage in the scheduling, task T4 no longer needs to be scheduled since task T4 is scheduled for candidate time slot 910.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, since there are multiple tasks, tasks T1, T5, T6, with the largest number of participants, task T1 which has the highest priority of the three tasks can be selected for scheduling.

At 708, candidate time slots suitable for scheduling the task can be determined. In the example of Tables 1 and 2, as shown in FIG. 9B, there are no candidate time slots between February 6 to February 19 suitable for scheduling task T1 with task T4 scheduled for candidate time slot 910 and at least one participant associated with task T1 (i.e., at least one user U3, U4, U5) unavailable for performing task T1 on February 17 and February 18. In other words, given that task T1 is scheduled for February 8 to February 10, there are no time slots of duration 4 days in which all the participants, users U3, U4, U5, associated with task T1 are available for performing task T1. The schedule for task T4 is a factor in determining candidate time slots suitable for scheduling task T1 since at least one participant associated with task T1 is also associated with task T4.

At 710, a check can be made to determine whether there is a candidate time slot suitable for scheduling the task. If it is determined that there is no suitable candidate time slot, then, at 712, a check can be made to determine whether there is a scheduled task that is available to reschedule. If there is a scheduled task that is available to reschedule, then, at 714, the most recently scheduled task of the scheduled tasks available to reschedule can be selected for rescheduling. The selected schedule task can then be descheduled. Intervening tasks (i.e., scheduled task which were scheduled after the scheduling of the task selected for rescheduling) can also be descheduled. The descheduled tasks can then be rescheduled. In the example of Tables 1 and 2, task T4 scheduled for candidate time slot 910 is a scheduled task available to reschedule since candidate time slots 912, 914 are suitable for scheduling task T4. Note that candidate time slot 910 is no longer suitable for scheduling task T4 since scheduling task T4 for candidate time slot 910 was already attempted. Also, task T4, which is a scheduled task that is available to reschedule, is the most recently scheduled task (e.g., there is no other scheduled task that is available to reschedule which was scheduled after task T4). Thus, task T4 can be selected for rescheduling and descheduled (i.e., no longer schedule task T4 for candidate time slot 910). At this stage in the scheduling, there are no intervening tasks (i.e., no scheduled tasks which were scheduled after the scheduling of task T4) which need to be descheduled.

Upon descheduling the scheduled task selected for rescheduling, at 708, candidate time slots suitable for scheduling the task (i.e., the descheduled task) can be determined. In the example of Tables 1 and 2, there are two candidate time slots, candidate time slot 912 and candidate time slot 914, suitable for scheduling task T4.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T4 can be scheduled for candidate time slot 912. In other words, task T4 can be rescheduled for February 9 to February 11.

Upon scheduling the task, at 720, a check can be made to determine whether all tasks that need to be scheduled have been scheduled or attempted to be scheduled. If all the tasks have not been scheduled or attempted to be scheduled, then, at 702, a task with the largest number of participants can be selected for scheduling from the tasks that need to be scheduled. In the example of Tables 1 and 2, tasks T1, T5, T6 can be selected for scheduling since they have the largest number of participants (i.e., three participants are associated with each of tasks T1, T5, T6) among the tasks that need to be scheduled. Note that at this stage in the scheduling, task T4 no longer needs to be scheduled since task T4 is scheduled for candidate time slot 912.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, since there are multiple tasks, tasks T1, T5, T6, with the largest number of participants, task T1 which has the highest priority of the three tasks can be selected for scheduling.

At 708, candidate time slots suitable for scheduling the task can be determined. In the example of Tables 1 and 2, as shown in FIG. 9C, there are no candidate time slots between February 6 to February 19 suitable for scheduling task T1 with task T4 scheduled for candidate time slot 912 and at least one participant associated with task T1 (i.e., at least one user U3, U4, U5) unavailable for performing task T1 on February 17 and February 18.

At 710, a check can be made to determine whether there is a candidate time slot suitable for scheduling the task. If it is determined that there is no suitable candidate time slot, then, at 712, a check can be made to determine whether there is a scheduled task that is available to reschedule. If there is a scheduled task that is available to reschedule, then, at 714, the most recently scheduled task of the scheduled tasks available to reschedule can be selected for rescheduling. In the example of Tables 1 and 2, task T4 scheduled for candidate time slot 912 is a scheduled task available to reschedule since candidate time slot 914 is suitable for scheduling task T4. Note that candidate time slots 910, 912 are no longer suitable for scheduling task T4 since scheduling task T4 for candidate time slots 910, 912 was already attempted. Also, task T4, which is a scheduled task that is available to reschedule, is the most recently scheduled task (e.g., there is no other scheduled task that is available to reschedule which was scheduled after task T4). Thus, task T4 can be selected for rescheduling and descheduled (i.e., no longer schedule task T4 for candidate time slot 912).

Upon descheduling the scheduled task selected for rescheduling, at 708, candidate time slots suitable for scheduling the task (i.e., the descheduled task) can be determined. In the example of Tables 1 and 2, there is one candidate time slot, candidate time slot 914, suitable for scheduling task T4.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T4 can be scheduled for candidate time slot 914. In other words, task T4 can be rescheduled for February 14 to February 16.

Upon scheduling the task, at 720, a check can be made to determine whether all tasks that need to be scheduled have been scheduled or attempted to be scheduled. If all the tasks have not been scheduled or attempted to be scheduled, then, at 702, a task with the largest number of participants can be selected for scheduling from the tasks that need to be scheduled. In the example of Tables 1 and 2, tasks T1, T5, T6 can be selected for scheduling since they have the largest number of participants (i.e., three participants are associated with each of tasks T1, T5, T6) among the tasks that need to be scheduled. Note that at this stage in the scheduling, task T4 no longer needs to be scheduled since task T4 is scheduled for candidate time slot 914.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, since there are multiple tasks, tasks T1, T5, T6, with the largest number of participants, task T1 which has the highest priority of the three tasks can be selected for scheduling.

At 708, candidate time slots suitable for scheduling the task can be determined. In the example of Tables 1 and 2, there are two candidate time slots between February 6 to February 19 suitable for scheduling task T1. As shown in FIG. 9D, a candidate time slot 920 suitable for scheduling task T1 may be from February 7 to February 10, and a candidate time slot 922 suitable for scheduling task T1 may be from February 8 to February 11. Note that, with task T4 scheduled for February 14 to February 16, there are no other time slots of duration 4 days in which all the participants, users U3, U4, U5, associated with task T1 are available for performing task T1.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T1 can be scheduled for candidate time slot 920.

Upon scheduling the task, at 720, a check can be made to determine whether all tasks that need to be scheduled have been scheduled or attempted to be scheduled. If all the tasks have not been scheduled or attempted to be scheduled, then, at 702, a task with the largest number of participants can be selected for scheduling from the tasks that need to be scheduled. In the example of Tables 1 and 2, tasks T5, T6 can be selected for scheduling since they have the largest number of participants (i.e., three participants are associated with each of tasks T5, T6) among the tasks that need to be scheduled. Note that at this stage in the scheduling, tasks T4, T1 no longer need to be scheduled since task T4 is scheduled for candidate time slot 914 and task T1 is scheduled for candidate time slot 920.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, since there are multiple tasks, tasks T5, T6, with the largest number of participants, task T5 which has a higher priority than task T5 can be selected for scheduling.

At 708, candidate time slots suitable for scheduling the task can be determined. In the example of Tables 1 and 2, there are two candidate time slots between February 6 to February 19 suitable for scheduling task T5. As shown in FIG. 9E, a candidate time slot 930 suitable for scheduling task T5 may be February 11, and a candidate time slot 932 suitable for scheduling task T5 may be February 17. Note that, with task T4 scheduled for February 14 to February 16 and task T1 scheduled for February 7 to February 10, there are no other time slots of duration 1 day in which all the participants, users U1, U2, U3, associated with task T5 are available for performing task T5. The schedules for tasks T4, T1 are factors in determining candidate time slots suitable for scheduling task T5 since at least one participant associated with task T5 is also associated with at least one of tasks T4, T1.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T5 can be scheduled for candidate time slot 930.

Upon scheduling the task, at 720, a check can be made to determine whether all tasks that need to be scheduled have been scheduled or attempted to be scheduled. If all the tasks have not been scheduled or attempted to be scheduled, then, at 702, a task with the largest number of participants can be selected for scheduling from the tasks that need to be scheduled. In the example of Tables 1 and 2, task T6 can be selected for scheduling since it has the largest number of participants (i.e., three participants are associated with task T6) among the tasks that need to be scheduled. Note that at this stage in the scheduling, tasks T4, T1, T5 no longer need to be scheduled since task T4 is scheduled for candidate time slot 914, task T1 is scheduled for candidate time slot 920, and task T5 is scheduled for candidate time slot 930.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, at this stage in the scheduling, there is one task, task T6, with the largest number of participants.

At 708, candidate time slots suitable for scheduling the task can be determined. In the example of Tables 1 and 2, as shown in FIG. 9F, there are no candidate time slots between February 6 to February 19 suitable for scheduling task T6 with task T4 scheduled for candidate time slot 914, task T1 is scheduled for candidate time slot 920, task T5 is scheduled for candidate time slot 930, and at least one participant associated with task T6 (i.e., at least one user U2, U4, U5) unavailable for performing task T6 on February 17 and February 18. The schedules for tasks T4, T1, T5 are factors in determining candidate time slots suitable for scheduling task T6 since at least one participant associated with task T6 is also associated with at least one of tasks T4, T1, T5.

At 710, a check can be made to determine whether there is a candidate time slot suitable for scheduling the task. If it is determined that there is no suitable candidate time slot, then, at 712, a check can be made to determine whether there is a scheduled task that is available to reschedule. If there is a scheduled task that is available to reschedule, then, at 714, the most recently scheduled task of the scheduled tasks available to reschedule can be selected for rescheduling. In the example of Tables 1 and 2, task T1 scheduled for candidate time slot 920 is a scheduled task available to reschedule since candidate time slot 922 is suitable for scheduling task T1. Task T5 scheduled for candidate time slot 930 is also a scheduled task available to reschedule since candidate time slot 932 is suitable for scheduling task T5. Note that task T4 scheduled for candidate time slot 914 is not available to reschedule since there are no candidate time slots suitable for scheduling task T4 (e.g., scheduling task T4 for candidate time slots 910, 912 was already attempted). Also, task T5 is the most recently scheduled task (i.e., scheduling of task T5 was performed after the scheduling of task T1). Thus, task T5 can be selected for rescheduling and descheduled (i.e., no longer schedule task T5 for candidate time slot 930).

Upon descheduling the scheduled task selected for rescheduling, at 708, candidate time slots suitable for scheduling the task (i.e., the descheduled task) can be determined. In the example of Tables 1 and 2, there is one candidate time slot, candidate time slot 932, suitable for scheduling task T5.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T5 can be scheduled for candidate time slot 932. In other words, task T5 can be rescheduled for February 17.

Upon scheduling the task, at 720, a check can be made to determine whether all tasks that need to be scheduled have been scheduled or attempted to be scheduled. If all the tasks have not been scheduled or attempted to be scheduled, then, at 702, a task with the largest number of participants can be selected for scheduling from the tasks that need to be scheduled. In the example of Tables 1 and 2, task T6 can be selected for scheduling since it has the largest number of participants (i.e., three participants are associated with task T6) among the tasks that need to be scheduled. Note that at this stage in the scheduling, tasks T4, T1, T5 no longer need to be scheduled since task T4 is scheduled for candidate time slot 914, task T1 is scheduled for candidate time slot 920, and task T5 is scheduled for candidate time slot 932.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, at this stage in the scheduling, there is one task, task T6, with the largest number of participants.

At 708, candidate time slots suitable for scheduling the task can be determined. In the example of Tables 1 and 2, there is one candidate time slot between February 6 to February 19 suitable for scheduling task T6. As shown in FIG. 9G, a candidate time slot 940 suitable for scheduling task T6 may be February 11. Note that, with task T4 scheduled for February 14 to February 16, task T1 scheduled for February 7 to February 10, and task T5 scheduled for February 17, there are no other time slots of duration 1 day in which all the participants, users U2, U4, U5, associated with task T6 are available for performing task T6. The schedules for tasks T4, T1, T5 are factors in determining candidate time slots suitable for scheduling task T6 since at least one participant associated with task T6 is also associated with at least one of tasks T4, T1, T5.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T6 can be scheduled for candidate time slot 940.

Upon scheduling the task, at 720, a check can be made to determine whether all tasks that need to be scheduled have been scheduled or attempted to be scheduled. If all the tasks have not been scheduled or attempted to be scheduled, then, at 702, a task with the largest number of participants can be selected for scheduling from the tasks that need to be scheduled. In the example of Tables 1 and 2, tasks T2, T3, T7 can be selected for scheduling since they have the largest number of participants (i.e., two participants are associated with each of tasks T2, T3, T7) among the tasks that need to be scheduled. Note that at this stage in the scheduling, tasks T4, T1, T5, T6 no longer need to be scheduled since task T4 is scheduled for candidate time slot 914, task T1 is scheduled for candidate time slot 920, task T5 is scheduled for candidate time slot 932, and task T6 is scheduled for candidate time slot 940.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, since there are multiple tasks, tasks T2, T3, T7, with the largest number of participants, task T2 which has the highest priority of the three tasks can be selected for scheduling.

At 708, candidate time slots suitable for scheduling the task can be determined. In the example of Tables 1 and 2, there is one candidate time slot between February 6 to February 19 suitable for scheduling task T2. As shown in FIG. 9H, a candidate time slot 950 suitable for scheduling task T2 may be from February 8 to February 11. Note that, with task T4 scheduled for February 14 to February 16, there are no other time slots of duration 4 days in which all the participants, users U6, U7, associated with task T2 are available for performing task T2. The schedule for task T4 is a factor in determining candidate time slots suitable for scheduling task T2 since at least one participant associated with task T2 is also associated with task T4.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T2 can be scheduled for candidate time slot 950.

Upon scheduling the task, at 720, a check can be made to determine whether all tasks that need to be scheduled have been scheduled or attempted to be scheduled. If all the tasks have not been scheduled or attempted to be scheduled, then, at 702, a task with the largest number of participants can be selected for scheduling from the tasks that need to be scheduled. In the example of Tables 1 and 2, tasks T3, T7 can be selected for scheduling since they have the largest number of participants (i.e., two participants are associated with each of tasks T3, T7) among the tasks that need to be scheduled. Note that at this stage in the scheduling, tasks T4, T1, T5, T6, T2 no longer need to be scheduled since task T4 is scheduled for candidate time slot 914, task T1 is scheduled for candidate time slot 920, task T5 is scheduled for candidate time slot 932, task T6 is scheduled for candidate time slot 940, and task T2 is scheduled for candidate time slot 950.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, since there are multiple tasks, tasks T3, T7, with the largest number of participants, task T3 which has a higher priority than task T7 can be selected for scheduling.

At 708, candidate time slots suitable for scheduling the task can be determined. In the example of Tables 1 and 2, there is one candidate time slot between February 6 to February 19 suitable for scheduling task T3. As shown in FIG. 9I, a candidate time slot 960 suitable for scheduling task T3 may be from February 7 to February 10. Note that, with task T4 scheduled for February 14 to February 16, task T5 scheduled for February 17, and task T6 scheduled for February 11, there are no other time slots of duration 4 days in which all the participants, users U1, U2, associated with task T3 are available for performing task T3. The schedule for tasks T4, T5, T6 are factors in determining candidate time slots suitable for scheduling task T3 since at least one participant associated with task T3 is also associated with at least one of tasks T4, T5, T6.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T3 can be scheduled for candidate time slot 960.

Upon scheduling the task, at 720, a check can be made to determine whether all tasks that need to be scheduled have been scheduled or attempted to be scheduled. If all the tasks have not been scheduled or attempted to be scheduled, then, at 702, a task with the largest number of participants can be selected for scheduling from the tasks that need to be scheduled. In the example of Tables 1 and 2, task T7 can be selected for scheduling since it has the largest number of participants (i.e., two participants are associated with task T7) among the tasks that need to be scheduled. Note that at this stage in the scheduling, tasks T4, T1, T5, T6, T2, T3 no longer need to be scheduled since task T4 is scheduled for candidate time slot 914, task T1 is scheduled for candidate time slot 920, task T5 is scheduled for candidate time slot 932, task T6 is scheduled for candidate time slot 940, task T2 is scheduled for candidate time slot 950, and task T3 is scheduled for candidate time slot 960.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, at this stage in the scheduling, there is one task, task T7, with the largest number of participants.

At 708, candidate time slots suitable for scheduling the task can be determined. In the example of Tables 1 and 2, as shown in FIG. 9J, there are no candidate time slots between February 6 to February 19 suitable for scheduling task T7 with task T4 scheduled for candidate time slot 914, task T2 is scheduled for candidate time slot 950, and at least one participant associated with task T7 (i.e., at least one user U6, U7) unavailable for performing task T7 on February 7, February 17, and February 18. The schedules for tasks T4, T2 are factors in determining candidate time slots suitable for scheduling task T7 since at least one participant associated with task T7 is also associated with at least one of tasks T4, T2.

At 710, a check can be made to determine whether there is a candidate time slot suitable for scheduling the task. If it is determined that there is no suitable candidate time slot, then, at 712, a check can be made to determine whether there is a scheduled task that is available to reschedule. If there is a scheduled task that is available to reschedule, then, at 714, the most recently scheduled task of the scheduled tasks available to reschedule can be selected for rescheduling. In the example of Tables 1 and 2, task T1 scheduled for candidate time slot 920 is a scheduled task available to reschedule since candidate time slot 922 is suitable for scheduling task T1. Note that task T5 scheduled for candidate time slot 932 is not available to reschedule since there are no candidate time slots suitable for scheduling task T5 (e.g., scheduling task T5 for candidate time slot 930 was already attempted). Task T4 scheduled for candidate time slot 914 is also not available to reschedule since there are no candidate time slots suitable for scheduling task T4 (e.g., scheduling task T4 for candidate time slots 910, 912 was already attempted). Tasks T6, T2, T3 scheduled for candidate time slots 940, 950, 960, respectively, are not available to reschedule since there are no candidate time slots suitable for scheduling tasks 940, 950, 960. Thus, task T1 can be selected for rescheduling and descheduled (i.e., no longer schedule task T1 for candidate time slot 920). Tasks T5, T6, T2, T3 can also be descheduled since tasks T5, T6, T2, T3 are intervening tasks which were scheduled after the scheduling of task T1 which is selected for rescheduling.

Upon descheduling the scheduled task selected for rescheduling, at 708, candidate time slots suitable for scheduling the task (i.e., the descheduled task) can be determined. In the example of Tables 1 and 2, there is one candidate time slot, candidate time slot 922, suitable for scheduling task T1.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T1 can be scheduled for candidate time slot 922. In other words, task T1 can be rescheduled for February 8 to February 11.

Upon scheduling the task, at 720, a check can be made to determine whether all tasks that need to be scheduled have been scheduled or attempted to be scheduled. If all the tasks have not been scheduled or attempted to be scheduled, then, at 702, a task with the largest number of participants can be selected for scheduling from the tasks that need to be scheduled. In the example of Tables 1 and 2, tasks T5, T6 can be selected for scheduling since they have the largest number of participants (i.e., three participants are associated with each of tasks T5, T6) among the tasks that need to be scheduled. Note that at this stage in the scheduling, tasks T4, T1 no longer need to be scheduled since task T4 is scheduled for candidate time slot 914 and task T1 is scheduled for candidate time slot 922.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, since there are multiple tasks, tasks T5, T6, with the largest number of participants, task T5 which has a higher priority than task T5 can be selected for scheduling.

At 708, candidate time slots suitable for scheduling the task can be determined. In the example of Tables 1 and 2, there are two candidate time slots between February 6 to February 19 suitable for scheduling task T5. As shown in FIG. 9K, a candidate time slot 934 suitable for scheduling task T5 may be February 7, and candidate time slot 932 suitable for scheduling task T5 may be February 17. Note that, with task T4 scheduled for February 14 to February 16 and task T1 scheduled for February 7 to February 10, there are no other time slots of duration 1 day in which all the participants, users U1, U2, U3, associated with task T5 are available for performing task T5.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T5 can be scheduled for candidate time slot 934. In other words, task T5 can be rescheduled for February 7.

Upon scheduling the task, at 720, a check can be made to determine whether all tasks that need to be scheduled have been scheduled or attempted to be scheduled. If all the tasks have not been scheduled or attempted to be scheduled, then, at 702, a task with the largest number of participants can be selected for scheduling from the tasks that need to be scheduled. In the example of Tables 1 and 2, task T6 can be selected for scheduling since it has the largest number of participants (i.e., three participants are associated with task T6) among the tasks that need to be scheduled. Note that at this stage in the scheduling, tasks T4, T1, T5 no longer need to be scheduled since task T4 is scheduled for candidate time slot 914, task T1 is scheduled for candidate time slot 922, and task T5 is scheduled for candidate time slot 934.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, at this stage in the scheduling, there is one task, task T6, with the largest number of participants.

At 708, candidate time slots suitable for scheduling the task can be determined. In the example of Tables 1 and 2, as shown in FIG. 9L, there are no candidate time slots between February 6 to February 19 suitable for scheduling task T6 with task T4 scheduled for candidate time slot 914, task T1 is scheduled for candidate time slot 922, task T5 is scheduled for candidate time slot 934, and at least one participant associated with task T6 (i.e., at least one user U2, U4, U5) unavailable for performing task T6 on February 17 and February 18.

At 710, a check can be made to determine whether there is a candidate time slot suitable for scheduling the task. If it is determined that there is no suitable candidate time slot, then, at 712, a check can be made to determine whether there is a scheduled task that is available to reschedule. If there is a scheduled task that is available to reschedule, then, at 714, the most recently scheduled task of the scheduled tasks available to reschedule can be selected for rescheduling. In the example of Tables 1 and 2, task T5 scheduled for candidate time slot 934 is a scheduled task available to reschedule since candidate time slot 932 is suitable for scheduling task T5. The other scheduled tasks are not available to reschedule since there are no candidate time slots suitable for scheduling those tasks. Thus, task T5 can be selected for rescheduling and descheduled (i.e., no longer schedule task T5 for candidate time slot 934).

Upon descheduling the scheduled task selected for rescheduling, at 708, candidate time slots suitable for scheduling the task (i.e., the descheduled task) can be determined. In the example of Tables 1 and 2, there is one candidate time slot, candidate time slot 932, suitable for scheduling task T5.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T5 can be scheduled for candidate time slot 932. In other words, task T5 can be rescheduled for February 17.

Upon scheduling the task, at 720, a check can be made to determine whether all tasks that need to be scheduled have been scheduled or attempted to be scheduled. If all the tasks have not been scheduled or attempted to be scheduled, then, at 702, a task with the largest number of participants can be selected for scheduling from the tasks that need to be scheduled. In the example of Tables 1 and 2, task T6 can be selected for scheduling since it has the largest number of participants (i.e., three participants are associated with task T6) among the tasks that need to be scheduled. Note that at this stage in the scheduling, tasks T4, T1, T5 no longer need to be scheduled since task T4 is scheduled for candidate time slot 914, task T1 is scheduled for candidate time slot 922, and task T5 is scheduled for candidate time slot 932.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, at this stage in the scheduling, there is one task, task T6, with the largest number of participants.

At 708, candidate time slots suitable for scheduling the task can be determined. In the example of Tables 1 and 2, there is one candidate time slot between February 6 to February 19 suitable for scheduling task T6. As shown in FIG. 9M, a candidate time slot 942 suitable for scheduling task T6 may be February 7. Note that, with task T4 scheduled for February 14 to February 16, task T1 scheduled for February 8 to February 11, and task T5 scheduled for February 17, there are no other time slots of duration 1 day in which all the participants, users U2, U4, U5, associated with task T6 are available for performing task T6.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T6 can be scheduled for candidate time slot 942.

Upon scheduling the task, at 720, a check can be made to determine whether all tasks that need to be scheduled have been scheduled or attempted to be scheduled. If all the tasks have not been scheduled or attempted to be scheduled, then, at 702, a task with the largest number of participants can be selected for scheduling from the tasks that need to be scheduled. In the example of Tables 1 and 2, tasks T2, T3, T7 can be selected for scheduling since they have the largest number of participants (i.e., two participants are associated with each of tasks T2, T3, T7) among the tasks that need to be scheduled. Note that at this stage in the scheduling, tasks T4, T1, T5, T6 no longer need to be scheduled since task T4 is scheduled for candidate time slot 914, task T1 is scheduled for candidate time slot 922, task T5 is scheduled for candidate time slot 932, and task T6 is scheduled for candidate time slot 942.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, since there are multiple tasks, tasks T2, T3, T7, with the largest number of participants, task T2 which has the highest priority of the three tasks can be selected for scheduling.

At 708, candidate time slots suitable for scheduling the task can be determined. In the example of Tables 1 and 2, there is one candidate time slot between February 6 to February 19 suitable for scheduling task T2. As shown in FIG. 9N, candidate time slot 950 suitable for scheduling task T2 may be from February 8 to February 11. Note that, with task T4 scheduled for February 14 to February 16, there are no other time slots of duration 4 days in which all the participants, users U6, U7, associated with task T2 are available for performing task T2.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T2 can be scheduled for candidate time slot 950. In other words, task T2 can be rescheduled for February 8 to February 11.

Upon scheduling the task, at 720, a check can be made to determine whether all tasks that need to be scheduled have been scheduled or attempted to be scheduled. If all the tasks have not been scheduled or attempted to be scheduled, then, at 702, a task with the largest number of participants can be selected for scheduling from the tasks that need to be scheduled. In the example of Tables 1 and 2, tasks T3, T7 can be selected for scheduling since they have the largest number of participants (i.e., two participants are associated with each of tasks T3, T7) among the tasks that need to be scheduled. Note that at this stage in the scheduling, tasks T4, T1, T5, T6, T2 no longer need to be scheduled since task T4 is scheduled for candidate time slot 914, task T1 is scheduled for candidate time slot 922, task T5 is scheduled for candidate time slot 932, task T6 is scheduled for candidate time slot 942, and task T2 is scheduled for candidate time slot 950.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, since there are multiple tasks, tasks T3, T7, with the largest number of participants, task T3 which has a higher priority than task T7 can be selected for scheduling.

At 708, candidate time slots suitable for scheduling the task can be determined. In the example of Tables 1 and 2, there is one candidate time slot between February 6 to February 19 suitable for scheduling task T3. As shown in FIG. 9O, a candidate time slot 962 suitable for scheduling task T3 may be from February 8 to February 11. Note that, with task T4 scheduled for February 14 to February 16, task T5 scheduled for February 17, and task T6 scheduled for February 7, there are no other time slots of duration 4 days in which all the participants, users U1, U2, associated with task T3 are available for performing task T3.

At 710, a check can be made to determine whether there is a candidate time slot suitable for scheduling the task. If it is determined that there is a suitable candidate time slot, then, at 718, the task can be scheduled for the suitable candidate time slot. If, at 708, multiple candidate time slots suitable for scheduling the task are determined, the task can be scheduled for one of the multiple candidate time slots. In the example of Tables 1 and 2, task T3 can be scheduled for candidate time slot 962. In other words, task T3 can be rescheduled for February 8 to February 11.

Upon scheduling the task, at 720, a check can be made to determine whether all tasks that need to be scheduled have been scheduled or attempted to be scheduled. If all the tasks have not been scheduled or attempted to be scheduled, then, at 702, a task with the largest number of participants can be selected for scheduling from the tasks that need to be scheduled. In the example of Tables 1 and 2, task T7 can be selected for scheduling since it has the largest number of participants (i.e., two participants are associated with task T7) among the tasks that need to be scheduled. Note that at this stage in the scheduling, tasks T4, T1, T5, T6, T2, T3 no longer need to be scheduled since task T4 is scheduled for candidate time slot 914, task T1 is scheduled for candidate time slot 922, task T5 is scheduled for candidate time slot 932, task T6 is scheduled for candidate time slot 942, task T2 is scheduled for candidate time slot 950, and task T3 is scheduled for candidate time slot 962.

At 704, a check can be made to determine whether there are multiple tasks with the largest number of participants. If it is determined that there are multiple tasks with the largest number of participants, then, at 706, the task having the highest priority of the multiple tasks can be selected for scheduling. In the example of Tables 1 and 2, at this stage in the scheduling, there is one task, task T7, with the largest number of participants.

At 708, candidate time slots suitable for scheduling the task can be determined. In the example of Tables 1 and 2, as shown in FIG. 9P, there are no candidate time slots between February 6 to February 19 suitable for scheduling task T7 with task T4 scheduled for candidate time slot 914, task T2 is scheduled for candidate time slot 950, and at least one participant associated with task T7 (i.e., at least one user U6, U7) unavailable for performing task T7 on February 7, February 17, and February 18.

At 710, a check can be made to determine whether there is a candidate time slot suitable for scheduling the task. If it is determined that there is no suitable candidate time slot, then, at 712, a check can be made to determine whether there is a scheduled task that is available to reschedule. If there are no scheduled task that is available to reschedule, then, at 716, the task can be determined to be not schedulable. Here, there are no candidate time slots suitable for scheduling the task given the schedules of the participants associated with the task. In the example of Tables 1 and 2, no scheduled tasks are available to reschedule since there are no candidate time slots suitable for scheduling any of the scheduled tasks. Thus, task T7 can be determined to be not schedulable. For example, in one embodiment, such tasks (e.g., task T7) can be indicated or otherwise identified as being not schedulable.

Upon determining the task to be not schedulable, at 720, a check can be made to determine whether all tasks that need to be scheduled have been scheduled or attempted to be scheduled. If all the tasks have been scheduled or attempted to be scheduled, then, at 722, it can be determined that a final schedule for the tasks that need to be scheduled have been generated. In the example of Tables 1 and 2, tasks T1-T7, which are the tasks which need to be scheduled, have been scheduled or attempted to be scheduled (e.g., tasks T1-T6 have been scheduled and task T7 has been determined to be not schedulable).

In some embodiment, additional operations may be performed to attempt to schedule a task determined to be not schedulable. For example, in one embodiment, a least relevant participant associated with a task that is not schedulable can be determined and this participant's scheduled time off not considered (or “excluded”) in scheduling the task. In the example of Tables 1 and 2, suppose user U6 is less relevant to performing task T7 than user U7. In this case, the scheduled time off of user U6, February 7 and February 18, is no longer considered in scheduling task T7. In other words, the scheduled time off of participant U6 is excluded from determining candidate time slots for scheduling task T7. As shown in FIG. 9Q, excluding the scheduled time off of user U6, there is a candidate time slot 970, February 18, suitable for scheduling task T7. Thus, task T7 can be scheduled or candidate time slot 970.

FIG. 9R shows an example user interface (UI) 900 that can be used to present a schedule for tasks, in accordance with an embodiment of the present disclosure. Illustrate UI 900 may be implemented within an application, such as resource access application 504 of FIG. 5. In the example of FIG. 9R, it is assumed that UI 900 is presenting a schedule for the tasks in the examples of Tables 1 and 2 above.

As shown in FIG. 9R, UI 900 can include a display pane 902 that displays the schedule for tasks T1-T7. Display pane 902 can include three portions 904a-904c. Portion 904a displays information regarding the participants associated with the tasks that are scheduled and shown in portion 904c. For example, as shown in FIG. 9R, content displayed in portion 904a indicates that users U1-U7 are participants associated with the scheduled tasks and indicates the scheduled time off of each indicated participant. Portion 904b displays information regarding the tasks that are scheduled and shown in portion 904c. For example, as shown in FIG. 9R, content displayed in portion 904b indicates that tasks T1-T7 are the tasks that are scheduled and indicates the participants associated with each indicated task.

Portion 904c displays a schedule generated for tasks T1-T7. For example, as shown in FIG. 9R, portion 904c may display a calendar view 906 which displays the schedule for tasks T1-T7. In the example of FIG. 9R, calendar view 906 displays a calendar for the duration February 6 to February 19. As shown in FIG. 9R, calendar view 906 includes a UI control (e.g., a bar) 908a to indicate that task T1 is scheduled for February 8 to February 11, a UI control (e.g., a bar) 908b to indicate that task T2 is scheduled for February 8 to February 11, a UI control (e.g., a bar) 908c to indicate that task T3 is scheduled for February 8 to February 11, a UI control (e.g., a bar) 908d to indicate that task T4 is scheduled for February 14 to February 16, a UI control (e.g., a bar) 908e to indicate that task T5 is scheduled for February 17, a UI control (e.g., a bar) 908f to indicate that task T6 is scheduled for February 7, and a UI control (e.g., a bar) 908g to indicate that task T7 is scheduled for February 18. In some embodiments, the UI controls displayed within calendar view 906 may be activated (e.g., clicked, tapped, or selected) to access the corresponding task. For example, a user can activate UI control 904a to access and/or obtain information about task T1.

It should be understood that the locations of portions 904a-904c within display pane 902 are simply provided as examples and that, in practice, the UI generated according to embodiments of the present disclosure may include portions 904a-904c at various locations within display pane 902 (e.g., include portions 904a-904c at locations within display pane 902 other than that shown in FIG. 9R).

FIG. 8 is a flow diagram of an illustrative process 800 for determining candidate time slots suitable for scheduling a task, in accordance with an embodiment of the present disclosure. Illustrative process 800 may be implemented, for example, within a cloud computing service, such as task scheduling service 508 of FIG. 5, and executed as part of illustrative process 700 described above.

Referring to process 800, at 802, all participants associated with a task can be identified. For example, all the participants associated with a task are identified because the schedules of these participants may impact the scheduling of the task. In other words, the schedules of the participants associated with the task may factor in determining candidate time slots suitable for scheduling the task.

At 804, other tasks associated with the participants associated with the task can be determined. For example, the other tasks of the participants, if scheduled, may impact the scheduling of the task since the participants may be busy performing those tasks during their respective scheduled times.

At 806, periods of time when the participants associated with the task are unavailable can be determined. A participant (e.g., a participant associated with the task) may be unavailable on a certain day or other period of time for various reasons, such as scheduled time off (e.g., vacation or other paid time off).

At 808, candidate time slots suitable for scheduling the task can be determined based on time slots for which the other tasks associated with the participants associated with the task are scheduled and the periods of time when the participants associated with the task are unavailable. Note that a candidate time slot suitable for scheduling the task is of a duration sufficient for performing the task (e.g., a length of a candidate time slot is at least of the estimated duration needed to perform the task). For example, if an estimated duration for performing a given task is three days, then a candidate time slot suitable for scheduling this task is of at least three days.

### Further Example Embodiments

The following examples pertain to further embodiments, from which numerous permutations and configurations will be apparent.

Example 1 includes a method including: identifying, by a computing device, a first task from a plurality of tasks that need to be scheduled; determining, by the computing device, other tasks associated with participants associated with the first task; determining, by the computing device, one or more periods of time when the participants associated with the first task are unavailable; determining, by the computing device, one or more candidate time slots for the first task based on time slots for which the other tasks are scheduled and the one or more periods of time when the participants associated with the first task are unavailable; and scheduling, by the computing device, the first task to be performed during one of the determined one or more candidate time slots.

Example 2 includes the subject matter of Example 1, wherein identifying of the first task includes determining that the first task is associated with a number of participants larger than that of other ones of the plurality of tasks.

Example 3 includes the subject matter of any of Examples 1 and 2, wherein identifying of the first task includes determining that the first task has a priority higher than that of other ones of the plurality of tasks associated with a same number of participants as the first task.

Example 4 includes the subject matter of any of Examples 1 through 3, also including: responsive to a determination that there are no candidate time slots for the first task, determining, by the computing device, whether there is a scheduled task available to reschedule; and, responsive to a determination that there are no scheduled tasks available to reschedule, indicating, by the computing device, the first task as being not schedulable.

Example 5 includes the subject matter of Example 4, further including, responsive to a determination that there are one or more scheduled tasks available to reschedule: selecting, by the computing device, one of the one or more scheduled tasks for rescheduling; descheduling, by the computing device, scheduled tasks which were scheduled subsequent to the scheduling of the selected one of the scheduled tasks for rescheduling; and rescheduling, by the computing device, the selected one of the scheduled tasks.

Example 6 includes the subject matter of any of Examples 1 through 5, further including causing, by the computing device, information regarding the scheduling of the first task to be displayed in a user interface (UI) of an application on a remote computing device.

Example 7 includes the subject matter of any of Examples 1 through 6, further including: identifying, by the computing device, a second task from the plurality of tasks that need to be scheduled; and scheduling, by the computing device, the second task by: determining other tasks associated with participants associated with the second task; determining other tasks associated with participants associated with the second task; determining one or more periods of time when the participants associated with the second task are unavailable; determining one or more candidate time slots for the second task based on time slots for which the other tasks are scheduled and the one or more periods of time when the participants associated with the second task are unavailable; and scheduling the second task to be performed during one of the determined one or more candidate time slots for the second task.

Example 8 includes the subject matter of Example 7, further including causing, by the computing device, information regarding the scheduling of the second task to be displayed in a user interface (UI) of an application on a remote computing device.

Example 9 includes a system including a processor and a non-volatile memory storing computer program code that when executed on the processor causes the processor to execute a process. The process includes: identifying a first task from a plurality of tasks that need to be scheduled; determining other tasks associated with participants associated with the first task; determining one or more periods of time when the participants associated with the first task are unavailable; determining one or more candidate time slots for the first task based on time slots for which the other tasks are scheduled and the one or more periods of time when the participants associated with the first task are unavailable; and scheduling the first task to be performed during one of the determined one or more candidate time slots.

Example 10 includes the subject matter of Example 9, wherein identifying of the first task includes determining that the first task is associated with a number of participants larger than that of other ones of the plurality of tasks.

Example 11 includes the subject matter of any of Examples 9 and 10, wherein identifying of the first task includes determining that the first task has a priority higher than that of other ones of the plurality of tasks associated with a same number of participants as the first task.

Example 12 includes the subject matter of any of Examples 9 through 11, wherein the process also includes: responsive to a determination that there are no candidate time slots for the first task, determining whether there is a scheduled task available to reschedule; and, responsive to a determination that there are no scheduled tasks available to reschedule, indicating the first task as being not schedulable.

Example 13 includes the subject matter of Example 12, wherein the process further includes, responsive to a determination that there are one or more scheduled tasks available to reschedule: selecting one of the one or more scheduled tasks for rescheduling; descheduling scheduled tasks which were scheduled subsequent to the scheduling of the selected one of the scheduled tasks for rescheduling; and rescheduling the selected one of the scheduled tasks.

Example 14 includes the subject matter of any of Examples 9 through 13, wherein the process further includes causing information regarding the scheduling of the first task to be displayed in a user interface (UI) of an application on a remote computing device.

Example 15 includes the subject matter of any of Examples 9 through 14, wherein the process further includes: identifying a second task from the plurality of tasks that need to be scheduled; and scheduling the second task by: determining other tasks associated with participants associated with the second task; determining other tasks associated with participants associated with the second task; determining one or more periods of time when the participants associated with the second task are unavailable; determining one or more candidate time slots for the second task based on time slots for which the other tasks are scheduled and the one or more periods of time when the participants associated with the second task are unavailable; and scheduling the second task to be performed during one of the determined one or more candidate time slots for the second task.

Example 16 includes the subject matter of Example 15, wherein the process further includes causing information regarding the scheduling of the second task to be displayed in a user interface (UI) of an application on a remote computing device.

Example 17 includes a non-transitory machine-readable medium encoding instructions that when executed by one or more processors cause a process to be carried out. The process includes: identifying a task from a plurality of tasks that need to be scheduled; determining other tasks associated with participants associated with the task; determining one or more periods of time when the participants associated with the task are unavailable; determining one or more candidate time slots for the task based on time slots for which the other tasks are scheduled and the one or more periods of time when the participants associated with the task are unavailable; and scheduling the task to be performed during one of the determined one or more candidate time slots.

Example 18 includes the subject matter of Example 17, wherein identifying of the task includes determining that the task is associated with a number of participants larger than that of other ones of the plurality of tasks.

Example 19 includes the subject matter of any of Examples 17 and 18, wherein identifying of the task includes determining that the task has a priority higher than that of other ones of the plurality of tasks associated with a same number of participants as the task.

Example 20 includes the subject matter of any of Examples 17 through 19, wherein the process also includes: responsive to a determination that there are no candidate time slots for the task, determining whether there is a scheduled task available to reschedule; and, responsive to a determination that there are no scheduled tasks available to reschedule, indicating the task as being not schedulable.

Example 21 includes the subject matter of any of Examples 17 through 19, wherein the process also includes: responsive to a determination that there are no candidate time slots for the task, determining whether there is a scheduled task available to reschedule; and responsive to a determination that there are one or more scheduled tasks available to reschedule: selecting one of the one or more scheduled tasks for rescheduling; descheduling scheduled tasks which were scheduled subsequent to the scheduling of the selected one of the scheduled tasks for rescheduling; and rescheduling the selected one of the scheduled tasks.

Example 22 includes the subject matter of Example 21, wherein the process further includes causing information regarding the scheduling of the task to be displayed in a user interface (UI) of an application on a remote computing device.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modules executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
identifying, by a computing device, a first task from a plurality of tasks that need to be scheduled;
determining, by the computing device, other tasks associated with participants associated with the first task;
determining, by the computing device, one or more periods of time when the participants associated with the first task are unavailable;
determining, by the computing device, one or more candidate time slots for the first task based on time slots for which the other tasks are scheduled and the one or more periods of time when the participants associated with the first task are unavailable; and
scheduling, by the computing device, the first task to be performed during one of the determined one or more candidate time slots.

2. The method of claim 1, wherein identifying of the first task includes determining that the first task is associated with a number of participants larger than that of other ones of the plurality of tasks.

3. The method of claim 1, wherein identifying of the first task includes determining that the first task has a priority higher than that of other ones of the plurality of tasks associated with a same number of participants as the first task.

4. The method of claim 1, further comprising:
responsive to a determination that there are no candidate time slots for the first task, determining, by the computing device, whether there is a scheduled task available to reschedule; and
responsive to a determination that there are no scheduled tasks available to reschedule, indicating, by the computing device, the first task as being not schedulable.

5. The method of claim 4, further comprising, responsive to a determination that there are one or more scheduled tasks available to reschedule:
selecting, by the computing device, one of the one or more scheduled tasks for rescheduling;
descheduling, by the computing device, scheduled tasks which were scheduled subsequent to the scheduling of the selected one of the scheduled tasks for rescheduling; and
rescheduling, by the computing device, the selected one of the scheduled tasks.

6. The method of claim 1, further comprising, causing, by the computing device, information regarding the scheduling of the first task to be displayed in a user interface (UI) of an application on a remote computing device.

7. The method of claim 1, further comprising:
identifying, by the computing device, a second task from the plurality of tasks that need to be scheduled; and
scheduling, by the computing device, the second task by:
determining other tasks associated with participants associated with the second task;
determining other tasks associated with participants associated with the second task;
determining one or more periods of time when the participants associated with the second task are unavailable;
determining one or more candidate time slots for the second task based on time slots for which the other tasks are scheduled and the one or more periods of time when the participants associated with the second task are unavailable; and
scheduling the second task to be performed during one of the determined one or more candidate time slots for the second task.

8. The method of claim 7, further comprising, causing, by the computing device, information regarding the scheduling of the second task to be displayed in a user interface (UI) of an application on a remote computing device.

9. A system comprising:
a processor; and
a non-volatile memory storing computer program code that when executed on the processor causes the processor to execute a process including:
identifying a first task from a plurality of tasks that need to be scheduled;
determining other tasks associated with participants associated with the first task;
determining one or more periods of time when the participants associated with the first task are unavailable;
determining one or more candidate time slots for the first task based on time slots for which the other tasks are scheduled and the one or more periods of time when the participants associated with the first task are unavailable; and
scheduling the first task to be performed during one of the determined one or more candidate time slots.

10. The system of claim 9, wherein identifying of the first task includes determining that the first task is associated with a number of participants larger than that of other ones of the plurality of tasks.

11. The system of claim 9, wherein identifying of the first task includes determining that the first task has a priority higher than that of other ones of the plurality of tasks associated with a same number of participants as the first task.

12. The system of claim 9, wherein the process further includes:
responsive to a determination that there are no candidate time slots for the first task, determining whether there is a scheduled task available to reschedule; and
responsive to a determination that there are no scheduled tasks available to reschedule, indicating the first task as being not schedulable.

13. The system of claim 12, wherein the process further includes, responsive to a determination that there are one or more scheduled tasks available to reschedule:
selecting one of the one or more scheduled tasks for rescheduling;
descheduling scheduled tasks which were scheduled subsequent to the scheduling of the selected one of the scheduled tasks for rescheduling; and
rescheduling the selected one of the scheduled tasks.

14. The system of claim 9, wherein the process further includes, causing information regarding the scheduling of the first task to be displayed in a user interface (UI) of an application on a remote computing device.

15. The system of claim 9, wherein the process further includes:
identifying a second task from the plurality of tasks that need to be scheduled; and
scheduling the second task by:
determining other tasks associated with participants associated with the second task;
determining other tasks associated with participants associated with the second task;
determining one or more periods of time when the participants associated with the second task are unavailable;
determining one or more candidate time slots for the second task based on time slots for which the other tasks are scheduled and the one or more periods of time when the participants associated with the second task are unavailable; and
scheduling the second task to be performed during one of the determined one or more candidate time slots for the second task.

16. The system of claim 15, wherein the process further includes, causing information regarding the scheduling of the second task to be displayed in a user interface (UI) of an application on a remote computing device.

17. A non-transitory machine-readable medium encoding instructions that when executed by one or more processors cause a process to be carried out, the process including:
identifying a task from a plurality of tasks that need to be scheduled;
determining other tasks associated with participants associated with the task;
determining one or more periods of time when the participants associated with the task are unavailable;
determining one or more candidate time slots for the task based on time slots for which the other tasks are scheduled and the one or more periods of time when the participants associated with the task are unavailable; and
scheduling the task to be performed during one of the determined one or more candidate time slots.

18. The machine-readable medium of claim 17, wherein identifying of the task includes determining that the task is associated with a number of participants larger than that of other ones of the plurality of tasks.

19. The machine-readable medium of claim 17, wherein identifying of the task includes determining that the task has a priority higher than that of other ones of the plurality of tasks associated with a same number of participants as the task.

20. The machine-readable medium of claim 17, wherein the process further includes:
responsive to a determination that there are no candidate time slots for the task, determining whether there is a scheduled task available to reschedule; and
responsive to a determination that there are one or more scheduled tasks available to reschedule:
selecting one of the one or more scheduled tasks for rescheduling;
descheduling scheduled tasks which were scheduled subsequent to the scheduling of the selected one of the scheduled tasks for rescheduling; and
rescheduling the selected one of the scheduled tasks.
